(19) United States
(12) Patent Application Publication
(10) Pub. No.: US 2011/0093875 A1
(43) Pub. Date: Apr. 21, 2011

(54) Online Shopping and Item Selection System and Method

(76) Inventors: Bonnie J. Simmons, West Chester, PA (US); John D. Simmons, West Chester, PA (US)

(21) Appl. No.: 12/975,336

(22) Filed: Dec. 21, 2010

Related U.S. Application Data
(63) Continuation of application No. 11/278,943, filed on Apr. 6, 2006, now abandoned.
(60) Provisional application No. 60/669,060, filed on Apr. 7, 2005.

(51) Int. Cl. H04N 7/16; H04N 5/445

(52) U.S. Cl. 725/5; 725/61

(57) ABSTRACT

A system for online shopping and item selection includes an audiovisual system coupled to a remote cable\satellite server, an audiovisual program transmitted from the remote cable\satellite server to the audiovisual system and an input device coupled to the audiovisual system. The audiovisual system includes a video display that displays the audiovisual program. The online shopping and item selection system includes at least one item displayed within the audiovisual program that is selectable using the input device. The system also includes a menu that is selectively displayable on the display information about purchasing the item onscreen.

### CROSS-REFERENCE TO RELATED APPLICATIONS

This application is a continuation of U.S. patent application Ser. No. 11/278,943, filed on Apr. 6, 2006, and this application claims the benefit of U.S. Provisional Patent Application No. 60/669,060, filed Apr. 7, 2005, entitled “Online Shopping and Item Selection System and Method.”

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

The present invention relates generally to an online shopping and item selection system and method, and more particularly, to an online shopping and item selection system and method implemented with cable television, satellite television and Internet broadcasting.

Broadcast television, cable television, satellite television and Internet broadcasting of multimedia programming are all technologies well known in the art. Modern cable television provides users with enhanced features, such as bi-directional enabled set-top control boxes which the customer can use to order on-demand or prerecorded programming. Interactive cable television is disclosed in U.S. Patent Application Publication No. 2005/0015804 A1 (“LaJoie et al.”), the contents of which is incorporated by reference herein.

Video transmission systems and methods for a home network are disclosed in, for example, U.S. Patent Application Publication No. 2004/0068753 A1 (“Robertson et al.”), the contents of which is incorporated by reference herein. The video transmission system of Robertson et al. provides television services and/or presentations to a plurality of televisions located at a customer premises. One method disclosed in Robertson et al. includes receiving by a set-top terminal located at a customer premises, via a transmission link that is coupled to the set-top terminal, a television service that was transmitted from a remote location, and transmitting the television service by the set-top terminal, via the transmission link, to a television that is located at the customer premises. Each set-top terminal typically includes a processor, communication components, and memory, and is connected to a television or other display device. While many conventional set-top terminals are stand-alone devices that are externally connected to a television, a set-top terminal and/or its functionality may be integrated into a television or other device, as will be appreciated by those of ordinary skill in the art. Companies like Scientific Atlanta and Motorola create set-top boxes for interactive television systems.

Shop at home programs broadcast over television, cable television and/or satellite television are also well known. The shop at home concept may be during a leased time slot (i.e., an infomercial) or an entire network may be dedicated to pitching wares such as the Home Shopping Network (HSN) or QVC. Such shop at home programs typically request that the user telephone in an order for a particular item or go to an internet website to purchase an item.

The concept of product placement in movies and television programs has become increasingly utilized for marketing in recent years. For example, during a movie, billboards may display advertisements for a particular product, or better yet, an actor or actress may be using a product prominently placed in the screen to effectively give endorsement of the product.

As noted in U.S. Patent Application Publication Number 2005/0022226 A1 (“Ackley et al.,” hereinafter, “Ackley”), the contents of which is incorporated by reference herein, interactive television and television commerce is widely pursued and currently understood by numerous companies and among companies developing software for interactive TV applications are WINK, OpenTV, ABC's Enhanced TV and GoldPocket Interactive. Ackley discloses a device that provides the ability to purchase products featured in a pre-recorded video through use of a video playback device, such as a DVD (Digital Versatile Disc) or High-Definition video player. The Ackley triggers are provided with the video that correspond to locations within the video where a product is shown. The playback device is configured to recognize these triggers and indicate to the user that a product may be available for purchase. When a product available for purchase is displayed in the video, an indicator appears on the screen which indicates to the user that this product is available for purchase. The indicator may for example be visual such as an icon or graphic. Further, Ackley discloses that a consumer purchases a video disc, brings it home, and places it into a video player in order to access a video. The user switches on the video player and watches the disc content. The Ackley movies can contain many examples of product placement, from brand name sodas to plush toys. Ackley et al. discloses that logic within the video playback device is configured to recognize the triggers which in turn cause logic running in the processor to display an indicator to the user, with or without pausing the video, an animating graphic of the item appears on the screen, along with a button that reads, “Add to Shopping Cart” or has similar text. Ackley discloses that by pressing the “Enter” key on his remote control, he selects the “Add to Shopping Cart” button. The processor stores this and all other selections in non-volatile memory in the video player. In another embodiment, Ackley et al. discloses trigger data can be provided separately from the video or video disc, e.g., the triggers may be provided to the video playback device through an Internet connection and stored in memory on the video playback device for access at a later time.

It is desirable to provide a online shopping and item selection system and method that is compatible with broadcast television, cable television, satellite television, and Internet broadcasting. It is desirable to provide an online shopping and item selection system and method that allows a user to switch to a shopping or information mode and to select among a plurality of items within an audiovisual program for information and/or purchasing.

### BRIEF SUMMARY OF THE INVENTION

Briefly stated, an embodiment of the present invention comprises a system for online shopping and item selection. The online shopping and item selection system includes an audiovisual system coupled to a remote server by a communication link, an audiovisual program transmitted from the remote server to the audiovisual system through the communication link and an input device coupled to the audiovisual system. The audiovisual system includes a video display that displays the audiovisual program. The online shopping and item selection system includes at least one item displayed within the audiovisual program that is selectable using the input device. The system also includes a menu that is selectively displayable on the display in order to display information about the item onscreen.

Another embodiment of the present invention comprises a method of online shopping and item selection. The method of online shopping selection includes providing an audiovisual system coupled to a remote server, transmitting an audiovisual program from the remote server to the audiovisual system, selecting an item displayed in the audiovisual program using an input device and providing information about purchasing the item onscreen.

In another aspect, embodiments of the present invention include an online shopping system implemented in conventional television broadcast, internet broadcast and cable and satellite television programs.

In yet another aspect, embodiments of the present invention include a computer-implemented online shopping selection system implemented in on-demand cable and satellite movies.

Embodiments of the present invention include articles of manufacture that each include a computer-readable medium holding computer-executable instructions for performing each method.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings an embodiment which is presently preferred. It should be understood, however, that the invention is not limited to the precise arrangements and instrumentalities shown.

In the drawings:

FIG. 1 is a front elevational view of an audiovisual system for implementing shopping methods in accordance with preferred embodiments of the present invention;

FIG. 2 is block schematic diagram depicting one possible system for implementing online shopping selection in accordance with the preferred embodiments of the present invention;

FIG. 3 is a screen shot of a cable television program guide viewable on the audiovisual system of FIG. 1;

FIG. 4 is a screen shot of a cable television onscreen menu viewable on the audiovisual system of FIG. 1;

FIG. 5 is a screen shot of a cable television onscreen on-demand menu viewable on the audiovisual system of FIG. 1;

FIG. 6 is a screen shot of a cable television onscreen on-demand movie selection menu viewable on the audiovisual system of FIG. 1;

FIGS. 7-11 are screen shots of a cable television on-demand show viewable on the audiovisual system of FIG. 1 showing an onscreen control menu bar;

FIG. 12 is a screen shot of a cable television on-demand show viewable on the audiovisual system of FIG. 1;

FIG. 13 is a screen shot of a cable television on-demand show viewable on the audiovisual system of FIG. 1 showing an onscreen control selector;

FIG. 14 is a screen shot of a cable television on-demand show viewable on the audiovisual system of FIG. 1 showing an onscreen control selector;

FIG. 15 is a screen shot of a cable television on-demand show viewable on the audiovisual system of FIG. 1 showing an onscreen control shopping mode selector in accordance with preferred embodiments of the present invention;

FIG. 16 is a flowchart of a method of purchasing at least one item through an audiovisual system in accordance with preferred embodiments of the present invention;

FIG. 17 is a flowchart of a method of purchasing at least one item through a cable or satellite server using a television and/or set-top box in accordance with preferred embodiments of the present invention;

FIG. 18 is a flowchart of a method of purchasing at least one item through a cable or satellite server using a television and/or set-top box in accordance with preferred embodiments of the present invention;

FIG. 19 is a flowchart of a method of purchasing at least one item through a cable or satellite server using a television and/or set-top box in accordance with preferred embodiments of the present invention;

FIG. 20 is a screen shot of a cable television on-demand show viewable on the audiovisual system of FIG. 1 showing an onscreen control shopping mode selector in accordance with preferred embodiments of the present invention;

FIG. 21A is a screen shot of a cable television on-demand show viewable on the audiovisual system of FIG. 1 showing an onscreen item selector in accordance with preferred embodiments of the present invention;

FIG. 21B is a screen shot of an information detail and purchasing selection menu bar displayed in accordance with selection of an item in FIG. 21A;

FIG. 22A is a screen shot of a cable television on-demand show viewable on the audiovisual system of FIG. 1 showing an onscreen item selector in accordance with preferred embodiments of the present invention;

FIG. 22B is a screen shot of an information detail and purchasing selection menu bar displayed in accordance with selection of an item in FIG. 22A;

FIG. 23A is a screen shot of a cable television on-demand show viewable on the audiovisual system of FIG. 1 showing an onscreen item selector in accordance with preferred embodiments of the present invention;

FIG. 23B is a screen shot of an information detail and purchasing selection menu bar displayed in accordance with selection of an item in FIG. 23A;

FIG. 24A is a screen shot of a cable television on-demand show viewable on the audiovisual system of FIG. 1 showing an onscreen item selector in accordance with preferred embodiments of the present invention;

FIG. 24B is a screen shot of an information detail and purchasing selection menu bar displayed in accordance with selection of an item in FIG. 24A;

FIG. 25A is a screen shot of a cable television on-demand show viewable on the audiovisual system of FIG. 1 showing an onscreen item selector in accordance with preferred embodiments of the present invention;

FIG. 25B is a screen shot of an information detail and purchasing selection menu bar displayed in accordance with selection of an item in FIG. 25A;

FIG. 26A is a screen shot of a cable television on-demand show viewable on the audiovisual system of FIG. 1 showing an onscreen item selector in accordance with preferred embodiments of the present invention;

FIG. 26B is a screen shot of an information detail and purchasing selection menu bar displayed in accordance with selection of an item in FIG. 26A; and

FIG. 27 is a perspective view of a remote control for controlling the audiovisual system of FIG. 1 configured to control menu selections in accordance with preferred embodiments of the present invention.

### DETAILED DESCRIPTION OF THE INVENTION

Certain terminology is used in the following description for convenience only and should not be construed as limiting. The word “a” as used in the claims and in the corresponding portions of the Specification means “one” or “more than one.” In the drawings, the same reference numerals are employed for designating the same elements throughout the figures.

As used herein, the Internet refers to the worldwide collection of networks and gateways that use the transmission control protocol/Internet protocol (TCP/IP) suite of protocols to communicate with one another. The World Wide Web (WWW) refers to the total set of interlinked hypertext documents residing on hypertext transport protocol (HTTP) servers all around the world. As used herein, the WWW is also intended to refer to documents accessed on secure servers, such as HTTP servers (HTTPS), which provide for encryption and transmission through a secure port. WWW documents, referred to herein as web pages, can be written in hypertext markup language (HTML). As used herein, the term “web site” refers to one or more related HTML documents and associated files, scripts, and databases, that is presented by an HTTP or HTTPS server on the WWW. The term “web browser” refers to software that lets a user view HTML documents and access files and software related to those documents.

As used herein, the term “server” should also be broadly construed to mean an entity such as a computer, computer platform, an adjunct to a computer or platform, or any component thereof, and a program that can respond to requests from a client. The server can be any remote device that sends cable television data, satellite television data, broadcast radiofrequency (RF) television data, internet broadcast programming data and the like. Preferably, the server stores, retrieves and sends digital program data such as digitized multimedia, audiovisual programs (AV programs) and control menus. The server also may include a display supporting a graphical user interface (GUI) for management and administration, and an Application Programming Interface (API) that provides extensions to enable application developers to extend and/or customize the core functionality thereof through software programs including Common Gateway Interface (CGI) programs, plug-ins, servlets, active server pages, server side include (SSI) functions or the like.

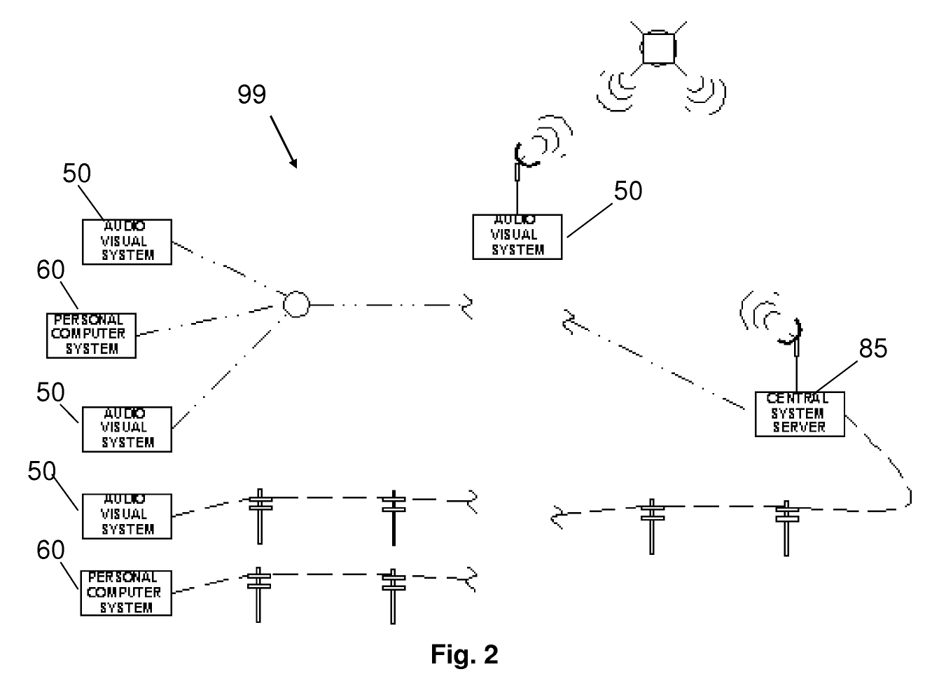

As used herein, the term “client” can be broadly understood to mean any entity, such as a the computer system 60 (FIG. 2), or specific components thereof such as a terminal, personal computer, mainframe computer, workstation, hand-held device, electronic book, personal digital assistant (PDA), peripheral, set-top terminal, a television, or a software program running on a computer directly or indirectly connected or connectable in any known or later-developed manner to any type of computer network, such as the Internet. For example, a representative client is a personal computer that is x86-, PowerPC, PENTIUM-based, or RISC-based. The computer includes an operating system such as UNIX, Linux, Mac OS, IBM OS/2 (commercially available from International Business Machines) or Microsoft Windows (commercially available from Microsoft Corporation of Redmond, Wash.), and includes a Web browser, such as Microsoft Internet Explorer, Netscape Navigator, Mozilla and the like, having a Java Virtual Machine (JVM) and support for application plug-ins or helper applications.

A client may also be a notebook computer, a handheld computing device (e.g., a PDA), an Internet appliance, a telephone, a cellular telephone, a television, a set-top terminal or any other such device connectable to the computer network.

Of course, a “client” can be broadly construed to mean any device that requests or gets a file or other data, and the “server” can be broadly construed to be any device that sends or downloads the requested file or other data.

The client and server can communicate using any system or transmission method capable of interconnecting two entities that are capable of communicating with each other, such as broadcast radio waves, cable television network, dedicated fiber-optic network, telephone, satellite, the Internet, an intranet, an extranet, or other computer networks. Networks can be land-based networks, wireless networks, and combinations thereof. Land-based networks include networks such as telephone lines, cable television lines, and direct physical connections. Wireless networks include networks that transmit information over the airwaves, such as cellular, satellite, microwave, packet radio, infrared line of sight, and spread spectrum technologies.

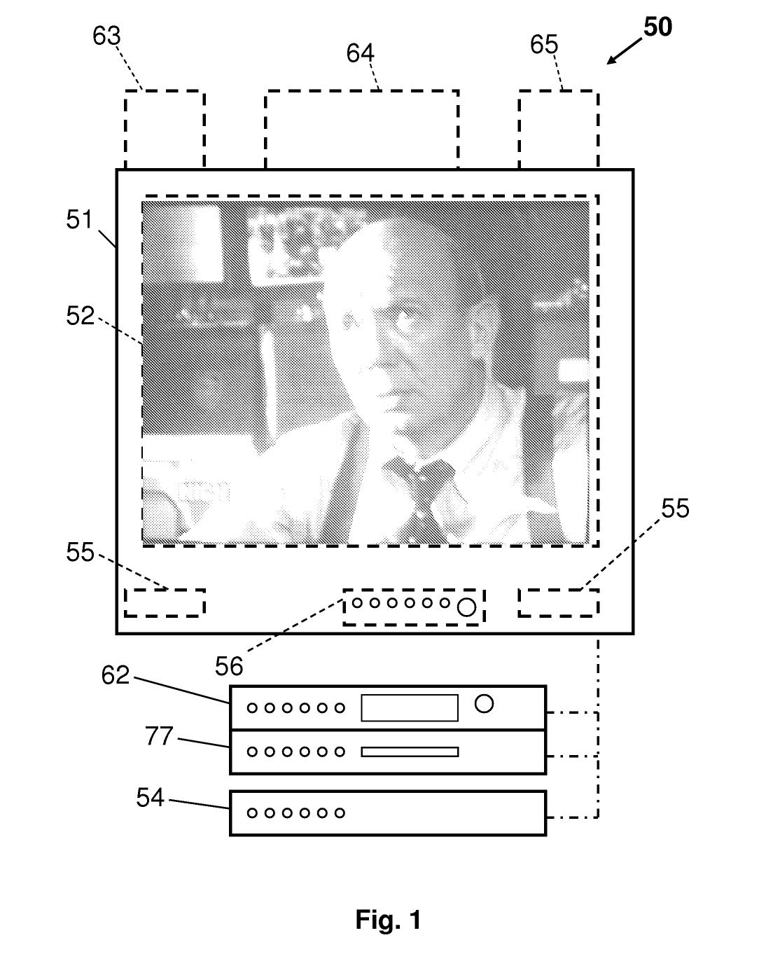

As used herein, a “set-top terminal” or “set-top box” means any control device that receives signals from cable, satellite, telephone, Internet or other similar communications medium and provides a corresponding output signal to a television or other multimedia display device such as a computer. An exemplary set-top terminal 54 is depicted in FIG. 1 and may be a model DCT2224/1161/ACDEG cable television converter commercially available from Motorola.

“DVD” once was the abbreviation for Digital Video Disc and later became Digital Versatile Disc but now “DVD” is just DVD, and really is no longer an acronym that it once was. As used herein “DVD” is an optical disc format for storing video, audio and/or data. It should be noted that a DVD disc may contain any combination of DVD-Video, DVD-Audio, and/or DVD-ROM application content. DVDs currently come in a variety of formats as the desire to increase storage capacity continues. For example, DVD-5 is the simplest format having a capacity about 4.7 Gigabytes (GBytes) of digital data, DVD-9 has a capacity of about 8.5 GBytes by using a second layer such that a player must automatically switch to the second layer and DVD-10 has a capacity of about 9.4 GBytes of data by storing data on both sides of the disc and requiring a user or the player to physically flip the DVD (the DVD-10 is sometimes called the “flipper” disc). Of course, any and all of these formats as well as other improved versions are suitable for use with the present invention.

As used herein, “online” means a bidirectional link that is transacted nearly real-time or with only slight delay such as through a bi-directional cable television network, a satellite network, a direct fiber optic communication network, a telephone network, an internet connection, a LAN/WAN or the like. Online should not be construed as strictly limited to internet transactions. Furthermore, online should not be construed to mean the type of payment option (i.e., on-line versus off-line debit transactions or credit card transactions).

Referring to the drawing in detail wherein like numerals are used throughout, FIG. 28 shows an overview of several implementations of an online shopping and item selection system 90. Preferably, the online shopping and item selection system 90 is implemented in an interactive or on-demand cable, satellite and/or internet television (i.e., a system that permits bidirectional communication and that broadcasts shows and movies). The online shopping and item selection system 90 provides the user with the ability to shop “instantly” while watching a broadcast, pre-recorded or on-demand program such as a television show or a movie.

FIG. 1 shows an audiovisual system 50 for implementing online shopping and item selection methods in accordance with preferred embodiments of the present invention. The audiovisual system 50 includes a display 52, a set-top control terminal or set-top box 54, internal speakers 55 and local controls 56. Preferably, the audiovisual system 50 includes a television 51. The television 51 may be sufficiently configured to communicate directly with a bidirectional cable television system, a satellite and phone system and/or the Internet without the set-top box 54 by having internal control circuits similar to those of a bi-directional set-top box 54.

Optionally, the audiovisual system 50 includes a surround sound system such as a surround sound receiver 62 at least two or more external speakers 63, 64, 65. The surround sound system 62-65 preferably has five speakers 63-65 and a subwoofer 0.1 (i.e., a “5.1 channel” system where “5” represents the speakers and “0.1” represents the subwoofer).

The audiovisual system 50 may include a set-top box 54 and/or a replay system such as Tivo®, Tivo is a registered trademark of Tivo, Inc., like the replay systems disclosed in U.S. Pat. Nos. 6,642,939 B1; 6,215,526 B1; 6,775,085 B2 and U.S. Patent Application Publication Numbers 2003/0219227 A1 and 2005/0050577 A1, the contents of which are all incorporated by reference herein. The set-top box 54 may be multifunctional and include on-demand cable or satellite communications as well as replay capabilities. Alternatively, the replay capabilities may occur at a central or remove server 85.

The audiovisual system 50 also includes a media player 77. The media player 77 may be a DVD player, a CD player, a CD read only memory (ROM) player, a flash memory device such as a flash random access memory (flash-RAM) drive, a tape player, a DVD player/recorder, a CD player/recorder, a CD-ROM player/recorder, a tape player/recorder, a record album turntable, a hard disk drive and the like. The media player 77 may alternatively be a simple port such as a USB port that accepts a USB flash memory device (i.e., a USB memory key). The media player 77 may also be other memory devices capable of storing multimedia data such as slideshows, movies, videos, pictures and the like. While shown with one media player 77, the portable multimedia projection system 100 may also include a plurality of media players 77 that are the same or different. For example, there may be a DVD player and a CD player/recorder and/or a flash memory reader; or the may be a DVD player and a DVD player/recorder. Other combinations of media players 77 may also be utilized. Preferably, the portable multimedia projection system 100 includes at least a DVD player.

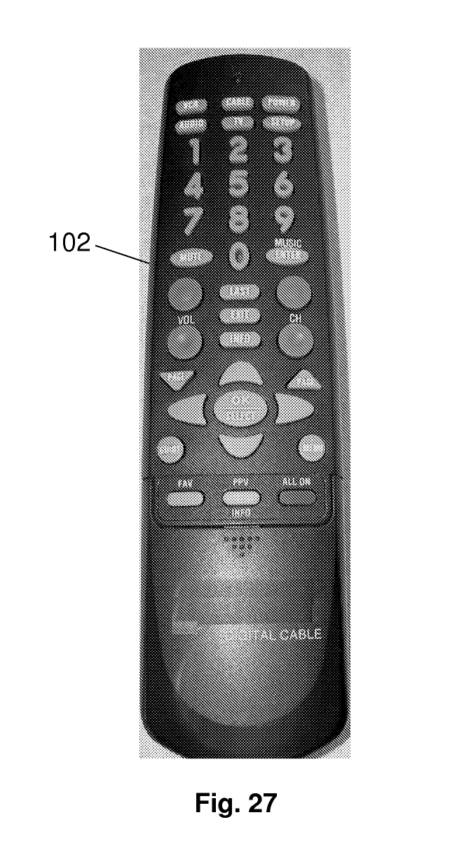

The audiovisual system 50 communicates with an input device 102 such as a remote control (FIG. 27). The input device 102 can be any type of device capable of providing the inputs described herein, such as keyboards, numeric keypads, touchscreens, pointing devices, touchpads, switches, styluses, and light pens. Preferably, the input device 102 is a remote control having a plurality of buttons such as numerals 0-9, mute, enter, guide, menu, favorite, pay per view, VCR, cable, power, audio TV, setup, all on, volume up, volume down, channel up, channel down, up select, down select, right select, left select, OK/select, previous, next, rewind, fast forward, play, pause, help, favorite, lock, TV/VCR, bypass and the like. FIG. 27 shows a remote control 102 for controlling the audiovisual system 50 of FIG. 1 configured to control menu selections in accordance with preferred embodiments of the present invention.

The remote control 102 transmits a wireless signal such as an infrared (IR), radiofrequency (RF), Bluetooth or the like. Bluetooth is a radiofrequency technology (commercially available from members of the Bluetooth Special Interest Group (SIG) trade association, Washington District of Columbia (D.C.)).

Alternatively, the remote control 102 may be implemented as a miniature touchscreen, like a personal digital assistant (PDA), a cellular telephone or the like.

Alternatively, the remote control 102 may be implemented by a software program for a conventional PDA that has wireless transmit capabilities such as IR, Bluetooth, RF or the like.

Of course, the remote control 102 may include a simplified set of buttons such as power, volume up, volume down, channel up, channel down, up select, down select, right select, left select and OK/select, in which case a majority of the functionality is implemented via onscreen “soft-buttons.” For example, while watching a program, a user may select the up select button to trigger a pop-up onscreen menu selection. The user can then use a combination of the keys to toggle through menu choices.

While certain terminology is used to describe buttons or menus, such words should not be construed as limiting. Any button or menu label may be utilized and/or any symbol may be associated with a particular function or menu button. Soft-buttons can be provided with on-screen pop-up menus and more detailed description fields that may differ depending upon a particular mode, screen or prior selection using the input device.

FIG. 2 is block schematic diagram depicting one possible system for implementing online shopping and item selection 90 in accordance with the preferred embodiments of the present invention. The online shopping and item selection system 90 includes a plurality of audiovisual systems 50 and/or personal computers 60 coupled to a remote server 85 by a communication link 99. An audiovisual program is transmitted from the remote server 85 to one or more of the audiovisual systems 50 through the communication link 99. Preferably, the communication link 99 comprises one or more of a cable television system, a satellite television system, a wireless local area network, a wireless wide area network, a telephone system, the Internet and a dedicated network.

The AV program may be transmitted with data compression encoding and decoding for playing files in compressed format such as WAV, WMA, MP3, MP3PRO, MPEG, MPEG-2, RA, RA-G2 or the like. The online shopping and item selection system 90 includes an input device 102 coupled to each audiovisual system 50 and/or personal computer system 60.

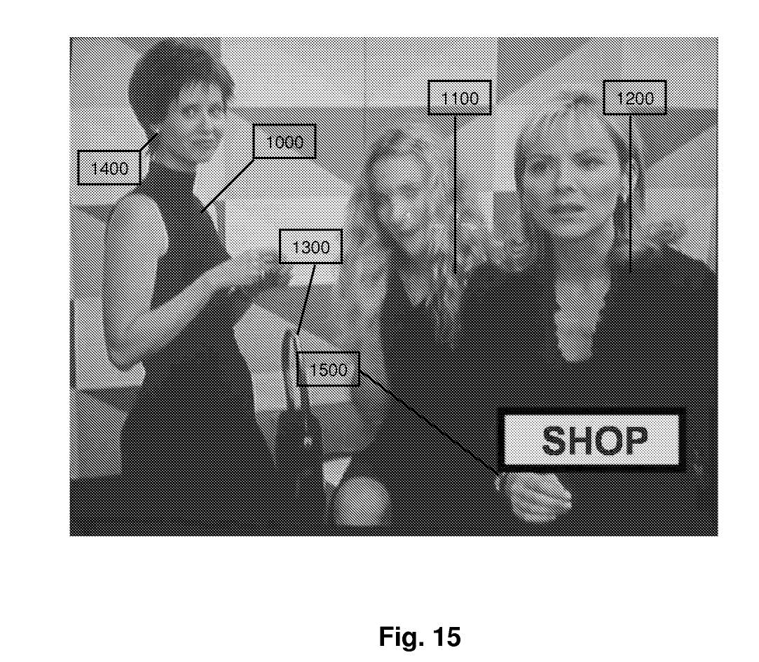

The audiovisual system 50 includes a video display 52 that displays the AV program. The online shopping and item selection system 90 includes at least one item 1000, 1100, 1200, 1300, 1400, 1500 (FIGS. 15 and 21A-21B, 22A-22B, 23A-23B, 24A-24B, 25A-25B, 26A-26B) displayed within the AV program that is selectable using the input device. The system also includes a menu that is selectively displayable on the display to convey information about purchasing the item 1000, 1100, 1200, 1300, 1400, 1500 onscreen.

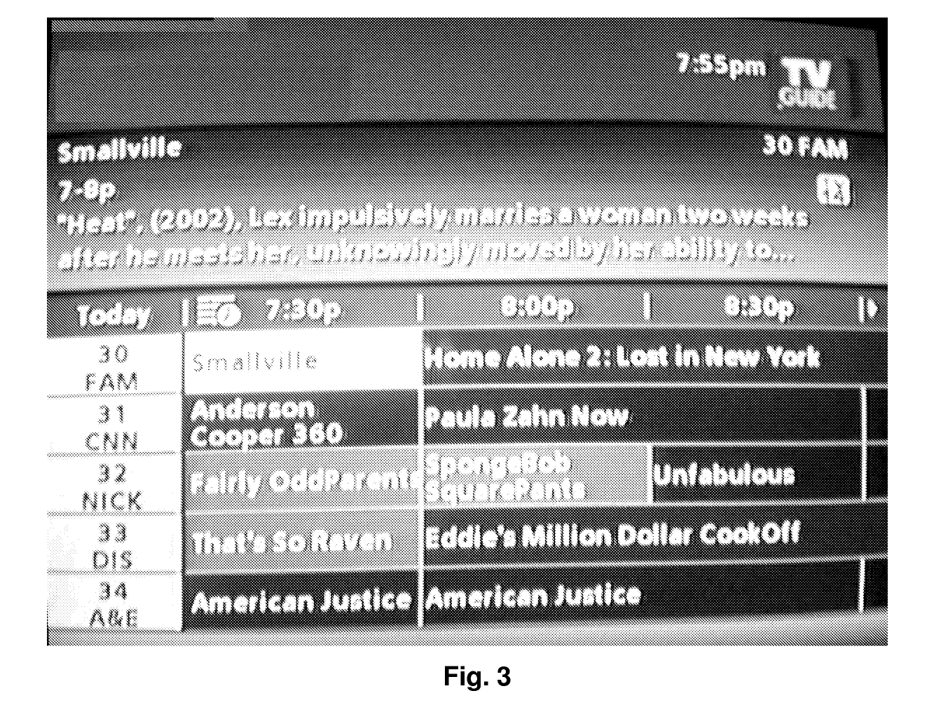

FIG. 3 is a screen shot of a conventional cable television program guide viewable on the audiovisual system 50 of FIG. 1. A user can use the remote control 102 to scroll up or down and left and right through the program guide using the up select, down select, right select, left select and OK/select keys.

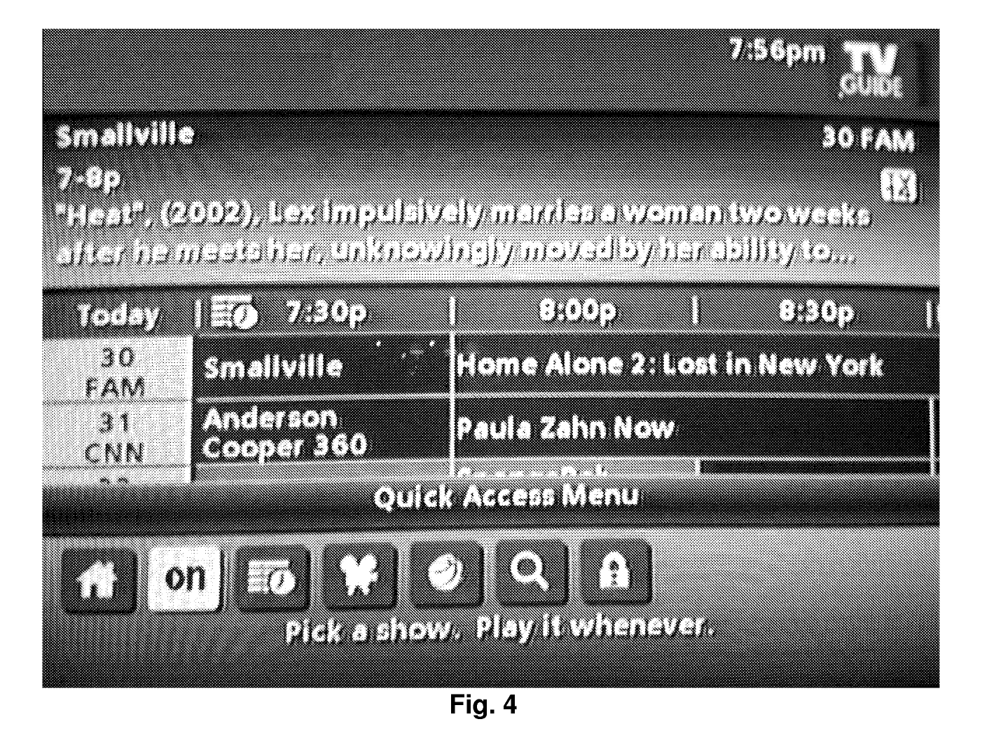

FIG. 4 is a screen shot of a cable television onscreen menu viewable on the audiovisual system 50 of FIG. 1. The onscreen menu includes to “tab” or “jump” to the next soft-buttons for home, on-demand, program guide, movie guide, search for sports, search by name and lock. A user can use the remote control 102 to tab through the menu choices using the up select, down select, right select, left select and OK/select keys.

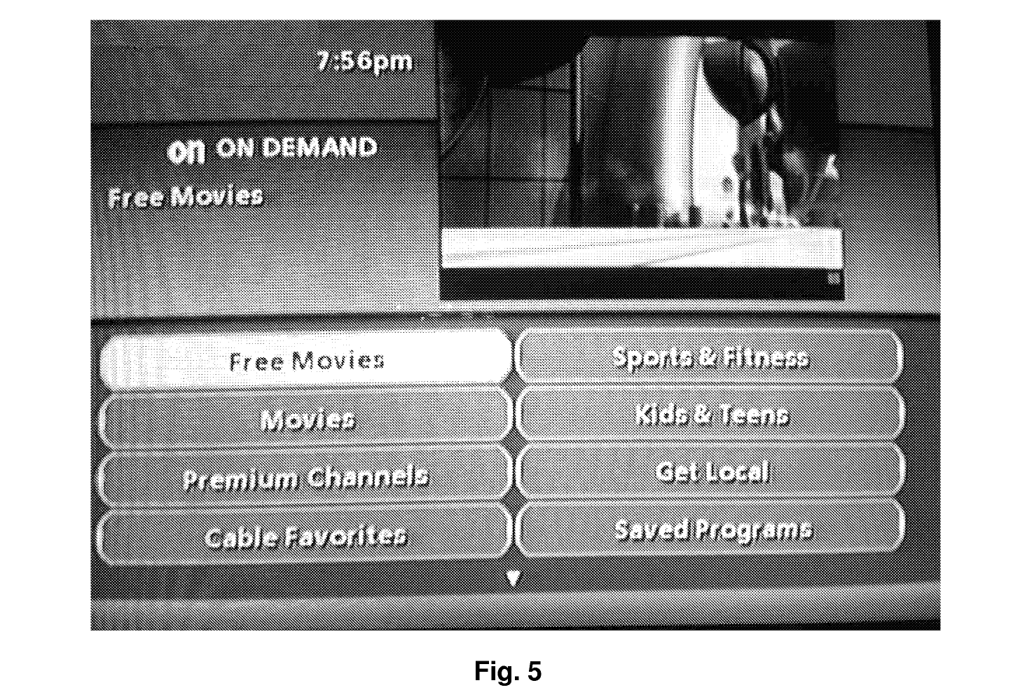

FIG. 5 is a screen shot of a cable television onscreen on-demand menu viewable on the audiovisual system 50 of FIG. 1. The on-demand menu includes categorical choices including free movies, movies, premium channels, cable favorites, sports & fitness, kids & teens, get local, saved programs or the like. A user can use the remote control 102 to tab through the menu categorical choices using the up select, down select, right select, left select and OK/select keys.

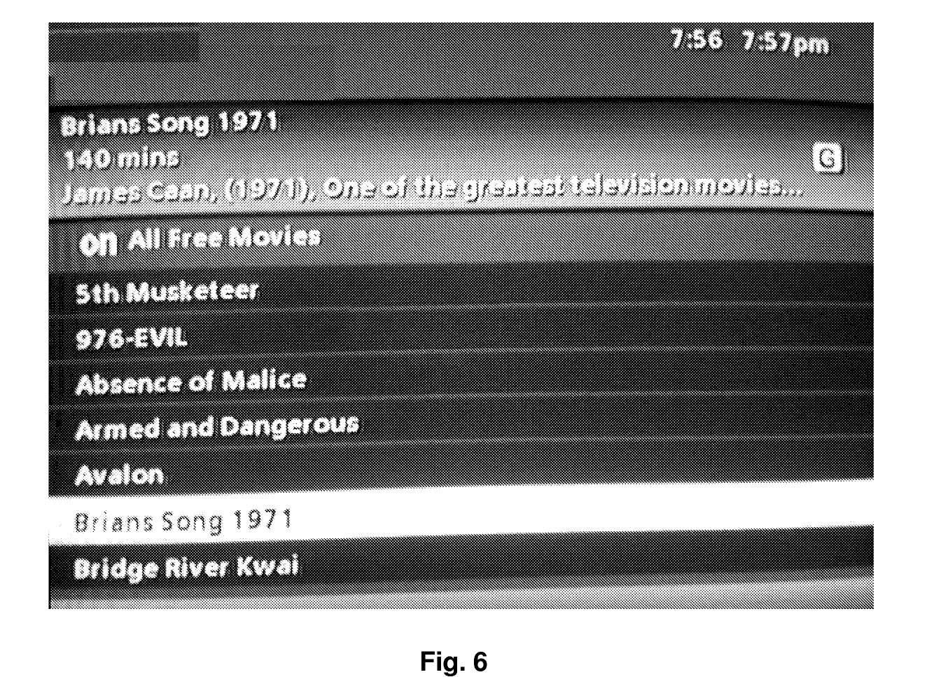

FIG. 6 is a screen shot of a cable television onscreen on-demand movie selection menu viewable on the audiovisual system 50 of FIG. 1. The onscreen on-demand movie selection menu includes individual movie title selections. A user can use the remote control 102 to tab through the individual movie title selections using the up select, down select, right select, left select and OK/select keys.

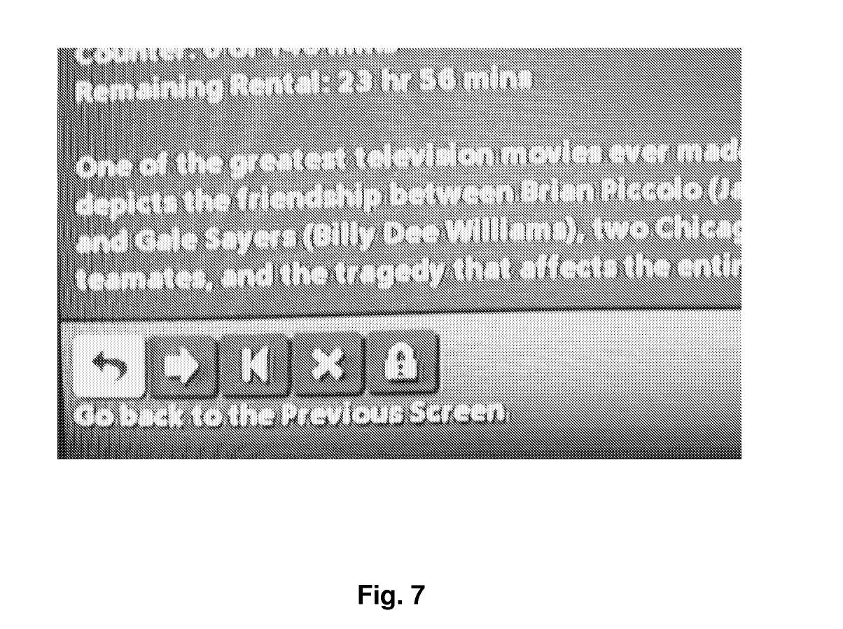

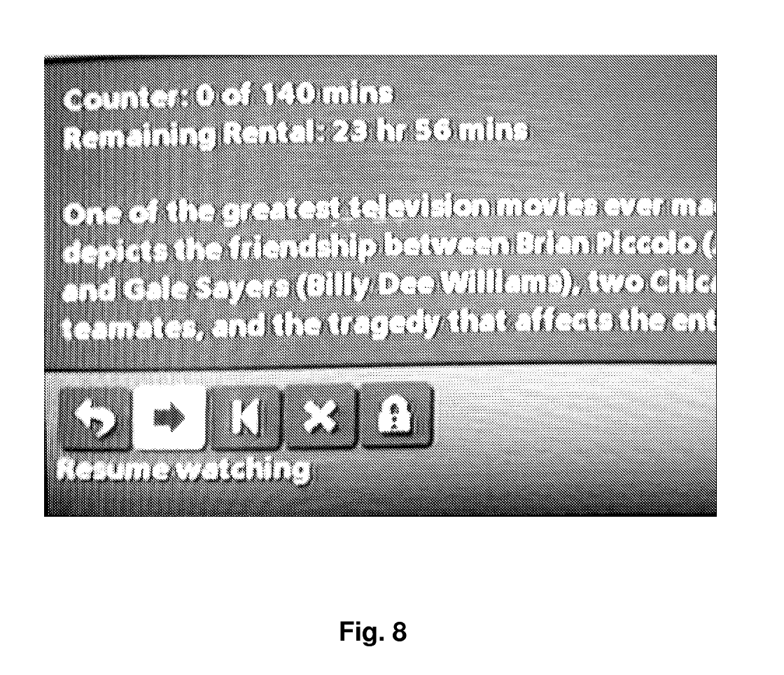

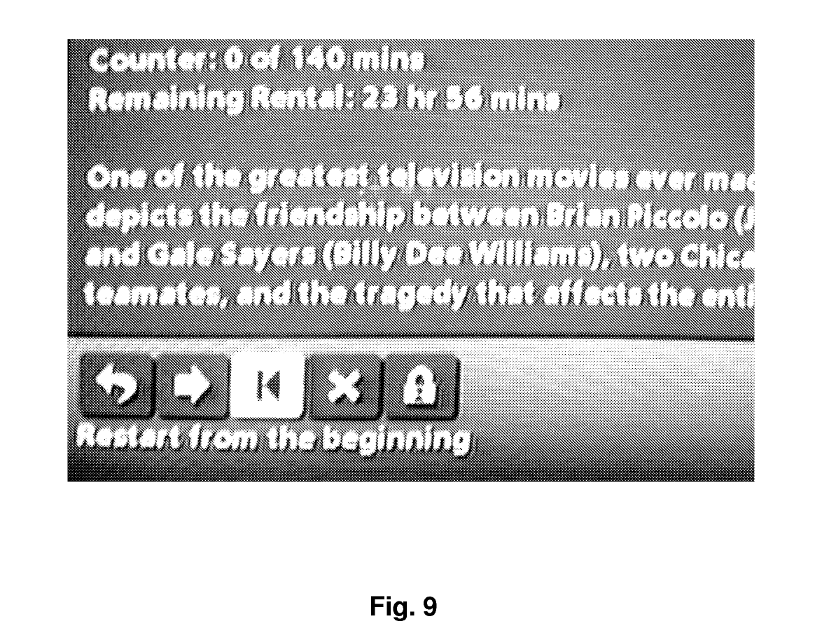

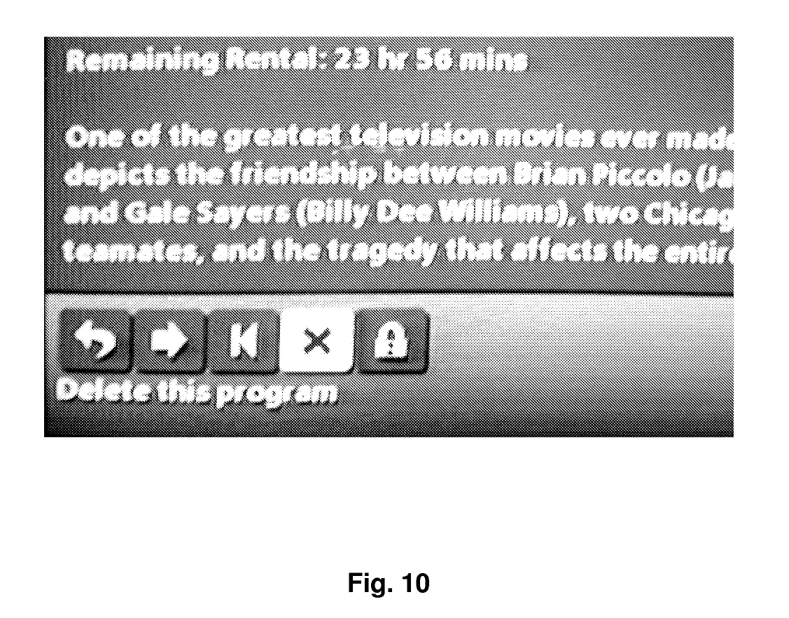

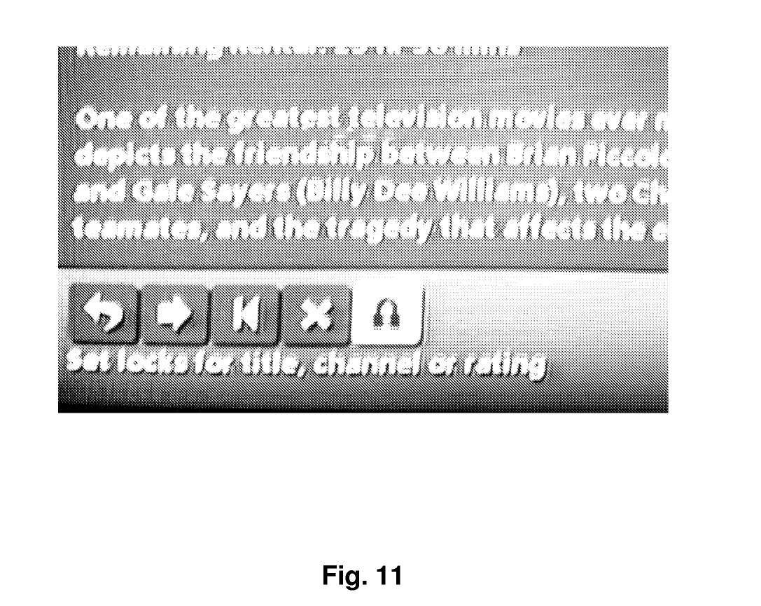

FIGS. 7-11 are screen shots of a cable television on-demand show viewable on the audiovisual system 50 of FIG. 1 showing an onscreen control menu bar. The onscreen control menu bar includes soft-buttons for previous screen, resume watching, restart from the beginning, delete the program and lock title/channel/rating. A user can use the remote control 102 to tab through the onscreen control menu bar soft-buttons using the up select, down select, right select, left select and OK/select keys. A cable television on-demand movie is controllable for viewing on the audiovisual system 50 of FIG. 1 using an onscreen control selector or soft-button. The onscreen control selector can be toggled through a plurality of control functions including pause, play, rewind, fast forward, stop and the like. A user can use the remote control 102 to toggle through the plurality of control functions using the up select, down select, right select, left select and OK/select keys.

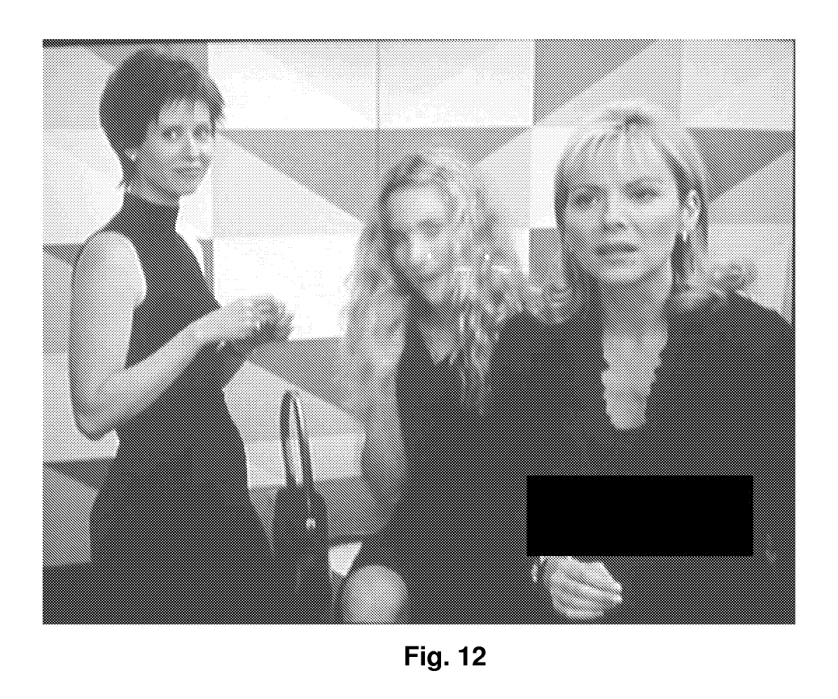

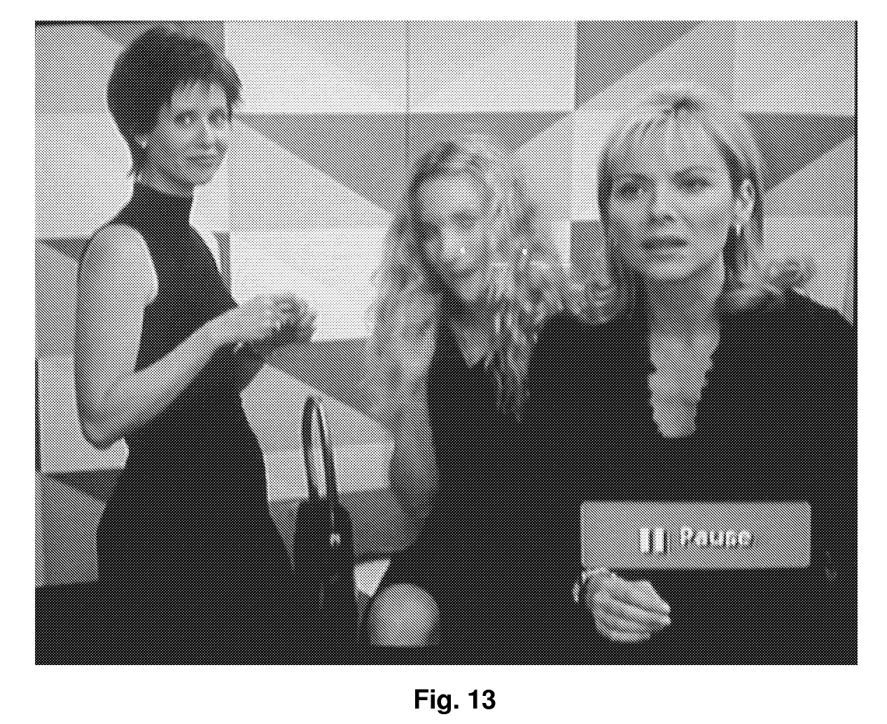

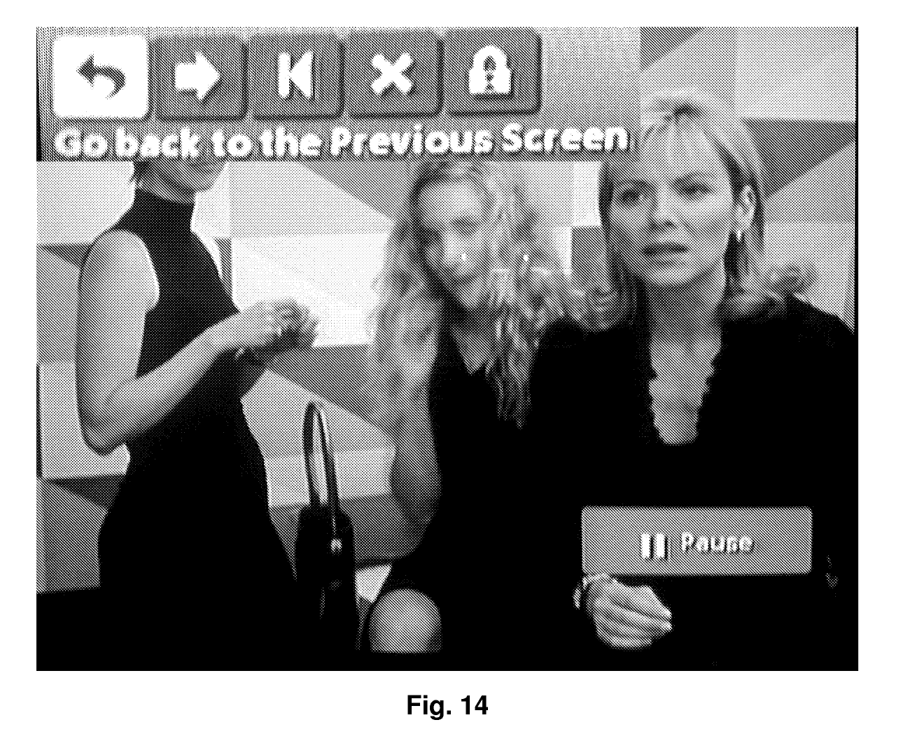

FIG. 12 is a screen shot of a cable television on-demand show viewable on the audiovisual system 50 of FIG. 1. FIG. 13 is a screen shot of a cable television on-demand show viewable on the audiovisual system 50 of FIG. 1 showing an onscreen control selector like FIG. 6 above. FIG. 14 is a screen shot of a cable television on-demand show viewable on the audiovisual system 50 of FIG. 1 showing an onscreen control selector like FIG. 6 above.

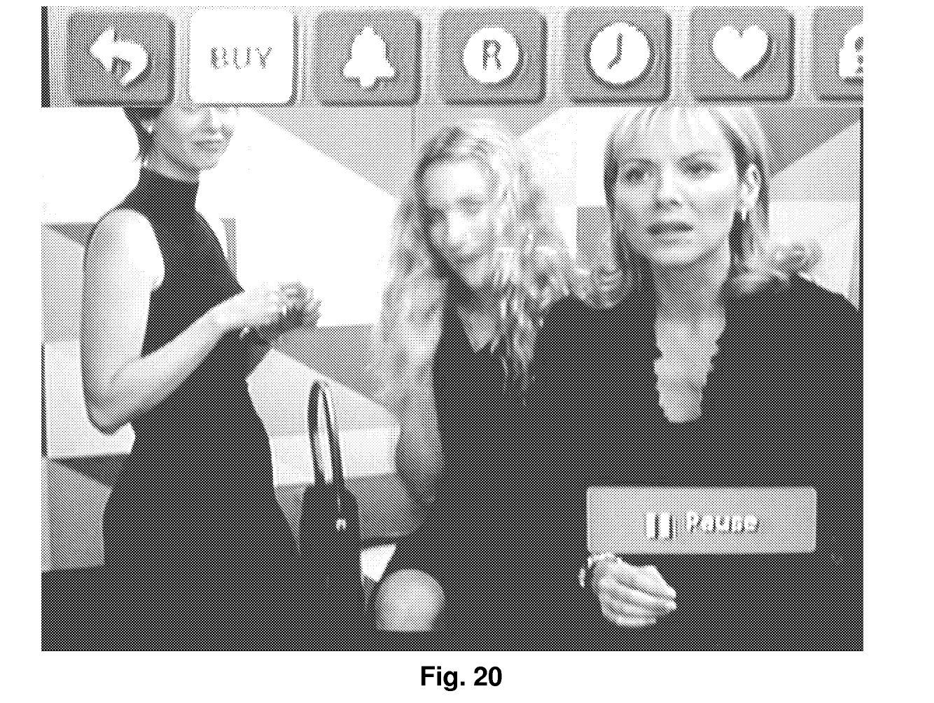

FIG. 15 is a screen shot of a cable television on-demand show viewable on the audiovisual system 50 of FIG. 1 showing an onscreen control shopping mode selector (“shopping/information mode”) in accordance with preferred embodiments of the present invention. The onscreen shopping mode selector can be selected using the remote control 102 to toggle through the plurality of control functions using the up select, down select, right select, left select and OK/select keys. Alternatively, the remote control 102 includes a dedicated “shopping-mode”or “Shop” button. FIG. 20 is a screen shot of a cable television on-demand show viewable on the audiovisual system 50 of FIG. 1 showing an alternate onscreen control shopping mode selector in accordance with preferred embodiments of the present invention.

In one exemplary embodiment shown in FIG. 15, the shopping/information mode may simply entail “painting” indicia on the screen such as tag numbers or other identifiers, here item 1000, 1100, 1200, 1300, 1400, 1500. The user can type in the tag number or tab between the numbers using the keys on the remote or other input device. Thus, the online shopping and item selection system 90 is not limited to prerecorded programs. The “painting” of the indicia can be provided by available technology to overlay graphics in a live program similar to a projected weather or traffic map or sports programs that “markup” the live, real-time screen. Alternatively, the online shopping and item selection system 90 may provide a menu on the screen at the top, bottom, sides or in “pop-up” which sufficiently describes the item and lets the user use the input device 102 to inquire about the item 1000, 1100, 1200, 1300, 1400, 1500 without having to call or separately engage the Internet. This effectuates a simplified information and purchasing system using the bidirectional broadcast television, cable television, satellite and/or Internet broadcast for live programs and/or transmitted prerecorded programs and/or saved programs.

The online shopping and item selection system 90 may also be used during live programs as well such as during soap operas, morning shows, reality television programs or the like. The system may also be used in conjunction with conventional home shopping television channels or programs such that a user may select items being modeled or displayed without need to telephone in an order. In order to use the system during a live program, a slight delay is necessary in order to encode the video with a selectable field that the user can choose. Alternatively, the items may have numbers or other identifiers “painted on” the screen 52, and a user can switch to shopping mode and choose from the identifiers in a sub-menu or pop-up menu in order to get more detailed information and or purchase the items. For example, as a shop at home television program displays a number of products that they are pitching (i.e., offering for sale or marketing), an image or some indicia may overly the transmitted program like a projected weather map. The user switches their audiovisual system 50 to “shopping mode” and chooses an item identifier (“1000,” “1100,” “1200,” “1300,” “1400,” “1500”) by typing a number in or tabbing to the painted on indicia. Information about the selected item is then displayed on the screen 52 and the user can choose features and/or quantities for purchase. Other steps in the transaction can also be implemented on screen 52 or the user may simply select “buy now” or “add to cart” or the like.

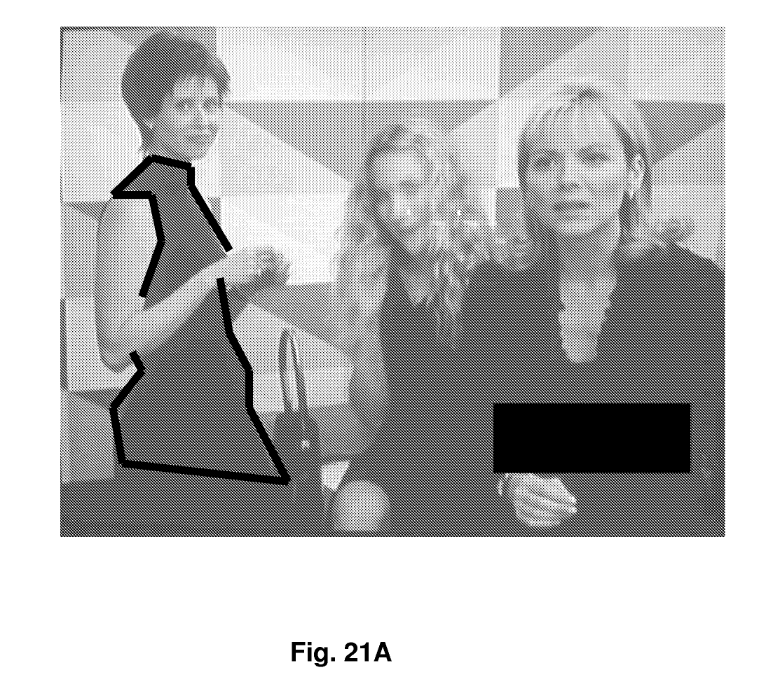

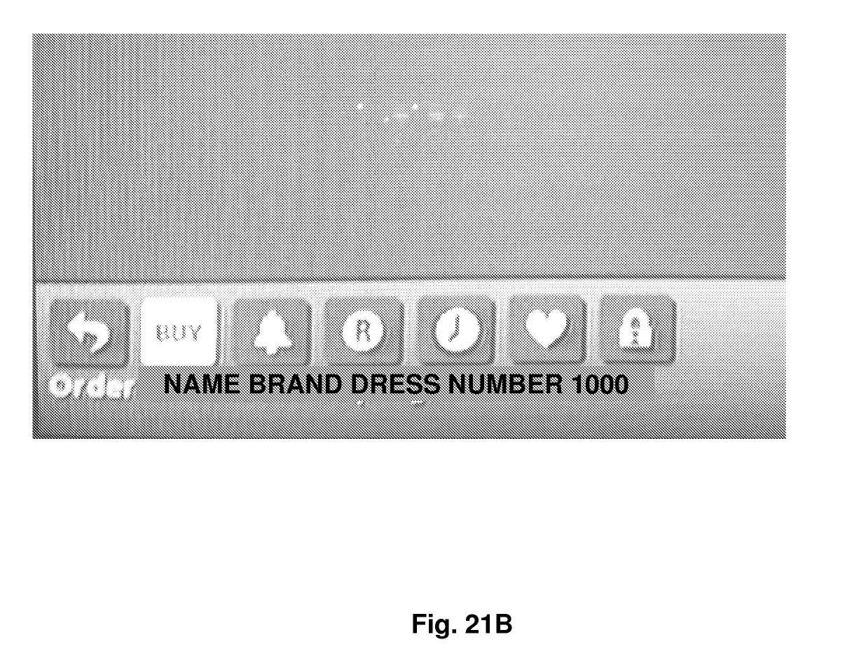

In another exemplary embodiment shown in FIGS. 21A-21B, 22A-22B, 23A-23B, 24A-24B, 25A-25B, 26A-26B, when the user switches to shopping mode, the scene “pauses” and the user can select items using keys on the remote or other navigational inputs to move between items. Preferably, the tagging of items 1000, 1100, 1200, 1300, 1400, 1500 is in every frame of an AV program such as a television or cable TV show (e.g., “Sex in the City”). However, it may be more expedient to only have one frame per scene that is selectable such that when a user switches to shopping mode, the AV program jumps to the tabbed or tagged frame in that scene. The user may be able to navigate forward and backward through frames to get back to a particular scene. For example, if during a show an actress is wearing designer shoes in scene one and the user is now in scene nine, the user can switch to shopping mode and navigate back through each of the scenes to get to the desired item.

One exemplary method of getting information and/or shopping will be described with respect to FIGS. 21A-21B, 22A-22B, 23A-23B, 24A-24B, 25A-25B, 26A-26B. A user watches a broadcast or prerecorded program, such as Sex in the City (i.e., an AV program). The AV program is tagged with items 1000, 1100, 1200, 1300, 1400, 1500 that can be queried by the user and/or purchased by the user. The user either selects a “buy” or “shop” button on their remote or uses the same navigation keys for pausing and playing the AV program to toggle into “shopping/information mode” (e.g., FIG. 15). Alternatively, a menu bar (FIG. 20) may appear with a shop button.

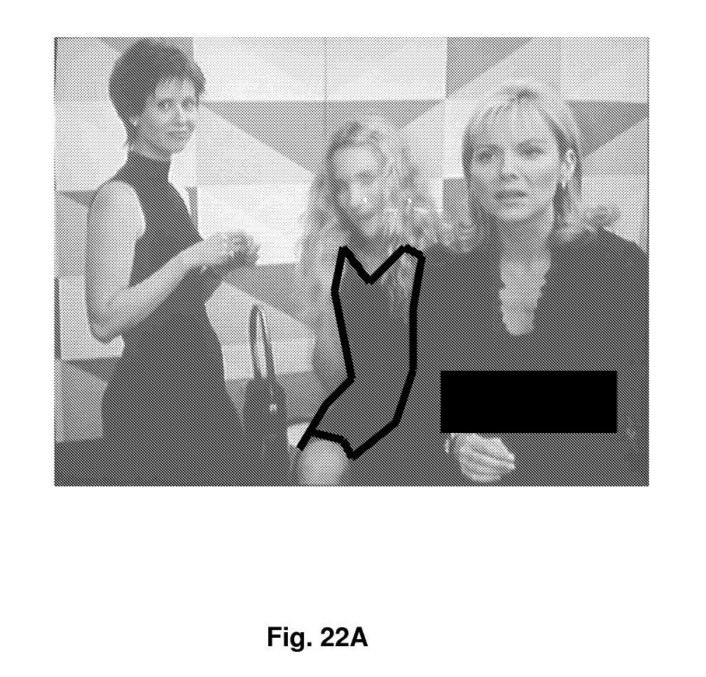

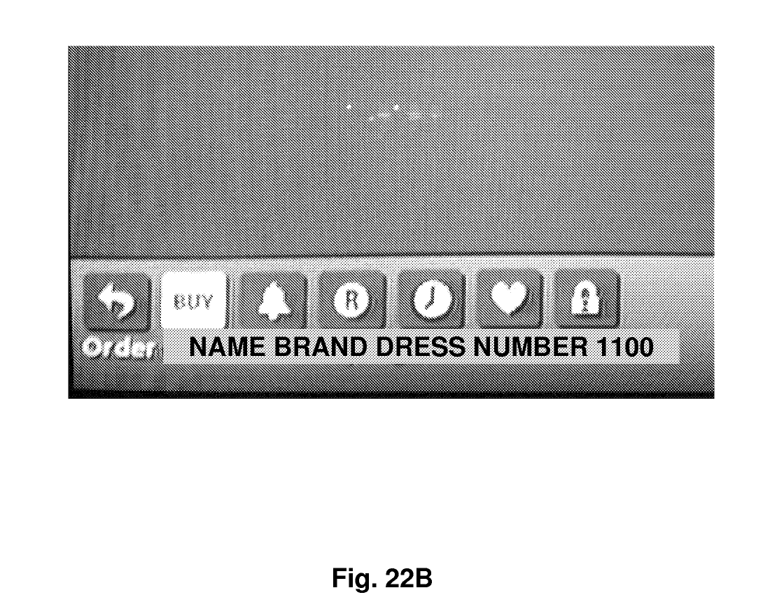

Once the user is in shopping/information mode, the user can tab to items 1000, 1100, 1200, 1300, 1400, 1500 using navigation keys on an input device 102, like arrow keys on remote control 102. FIG. 21A is a screen shot of a cable television on-demand show viewable on the audiovisual system 50 of FIG. 1 showing an onscreen item selector in accordance with preferred embodiments of the present invention. FIG. 21B is a screen shot of an information detail and purchasing selection menu bar displayed in accordance with selection of an item in FIG. 21A. FIG. 21B shows that the selected item is a “Name Brand Dress Number 1000.” Of course, other more detailed information can also be displayed such as sizes, colors, accessories and the like. If the user actually wants another item 1100, 1200, 1300, 1400, 1500 shown on the screen, the user uses the navigation keys on the remote control 102 to tab to the next or previous item, such as FIG. 22A.

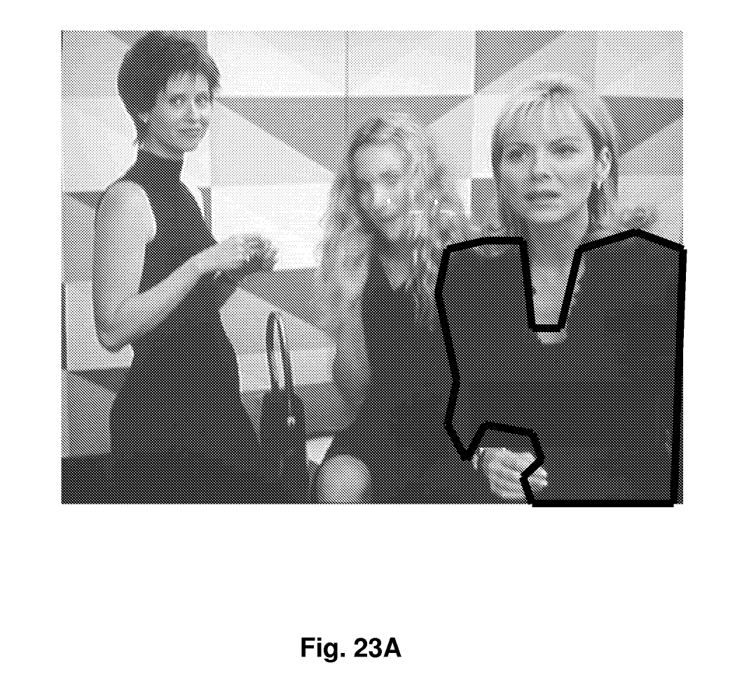

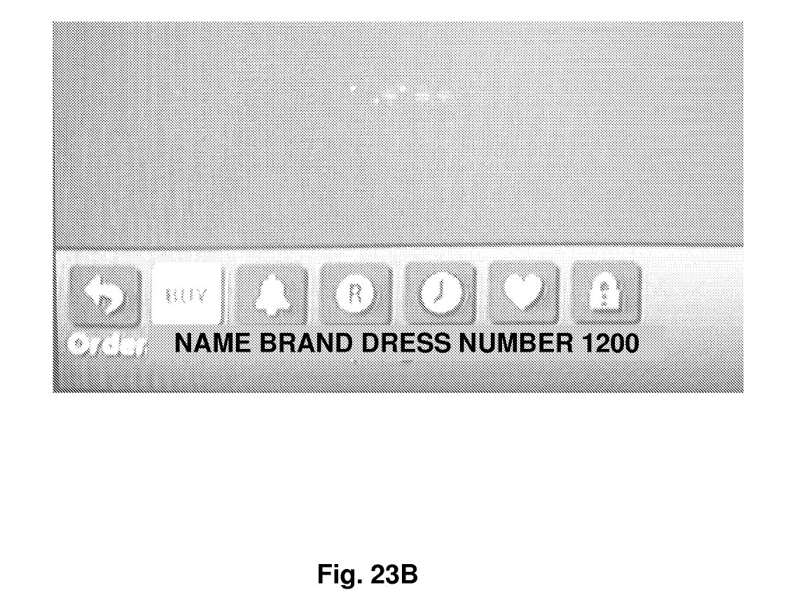

FIG. 22A is a screen shot of a cable television on-demand show viewable on the audiovisual system 50 of FIG. 1 showing an onscreen item selector. FIG. 22B is a screen shot of an information detail and purchasing selection menu bar displayed in accordance with selection of an item in FIG. 22A. FIG. 22B shows that the selected item is a “Name Brand Dress Number 1100.” Of course, other more detailed information can also be displayed such as sizes, colors, accessories and the like. If the user actually wants another item 1000, 1200, 1300, 1400, 1500 shown on the screen, the user uses the navigation keys on the remote control 102 to tab to the next or previous item, such as FIG. 23A.

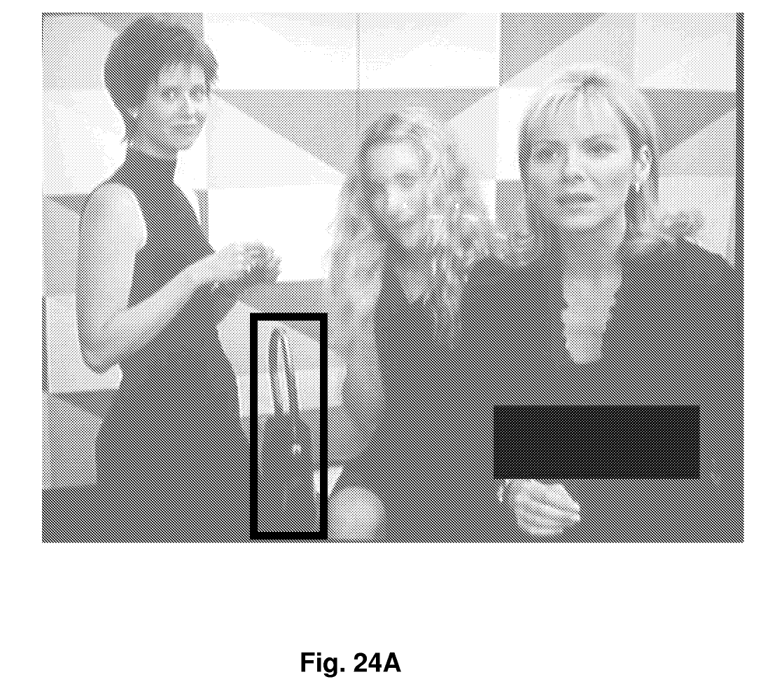

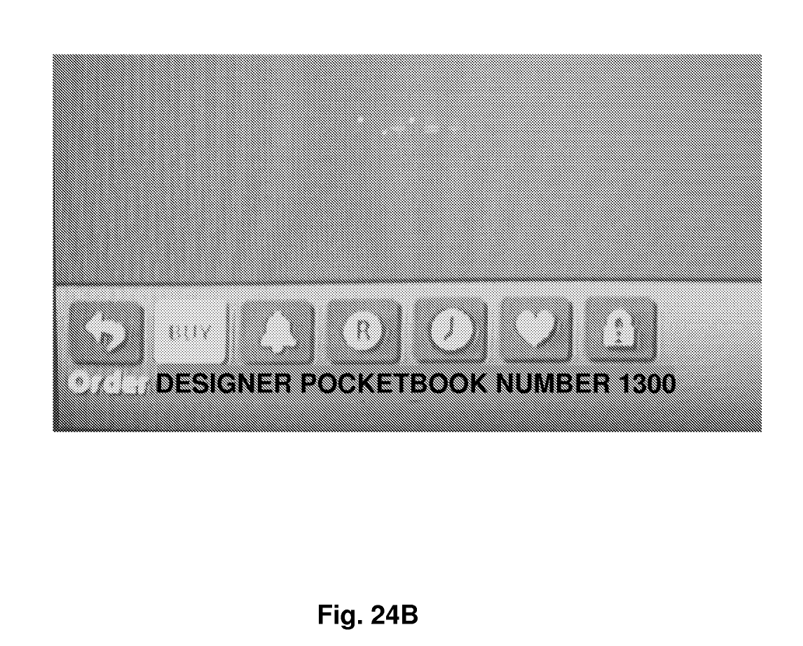

FIG. 23A is a screen shot of a cable television on-demand show viewable on the audiovisual system 50 of FIG. 1 showing an onscreen item selector in accordance with preferred embodiments of the present invention. FIG. 23B is a screen shot of an information detail and purchasing selection menu bar displayed in accordance with selection of an item in FIG. 23A. FIG. 23b shows that the selected item is a “Name Brand Dress Number 1200.” Of course, other more detailed information can also be displayed such as sizes, colors, accessories and the like. If the user actually wants another item 1000, 1100, 1300, 1400, 1500 shown on the screen, the user uses the navigation keys on the remote control 102 to tab to the next or previous item, such as FIG. 24A.

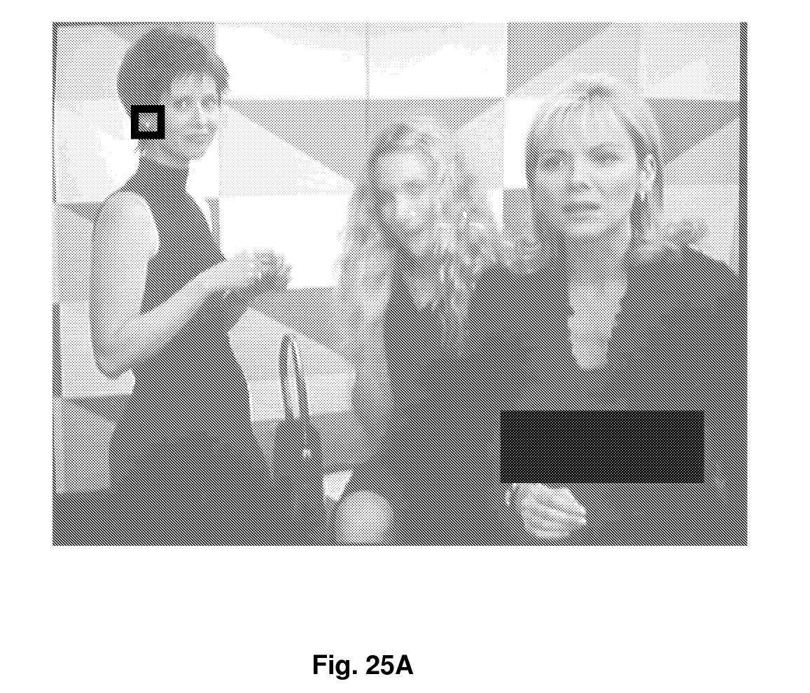

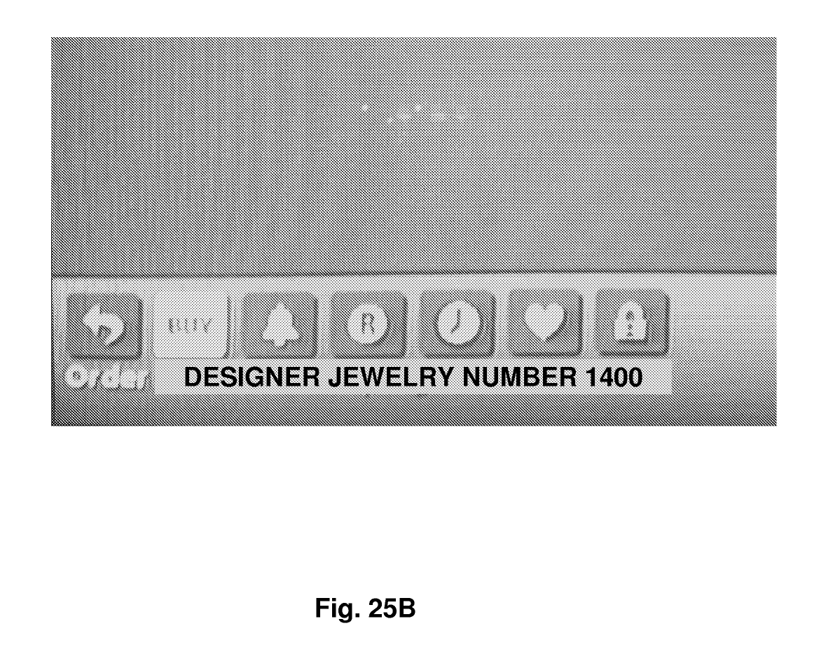

FIG. 24A is a screen shot of a cable television on-demand show viewable on the audiovisual system 50 of FIG. 1 showing an onscreen item selector in accordance with preferred embodiments of the present invention. FIG. 24B is a screen shot of an information detail and purchasing selection menu bar displayed in accordance with selection of an item in FIG. 24A. FIG. 24B shows that the selected item is a “Designer Pocketbook Number 1300.” Of course, other more detailed information can also be displayed such as sizes, colors, accessories and the like. If the user actually wants another item 1000, 1100, 1200, 1400, 1500 shown on the screen, the user uses the navigation keys on the remote control 102 to tab to the next or previous item, such as FIG. 25A.

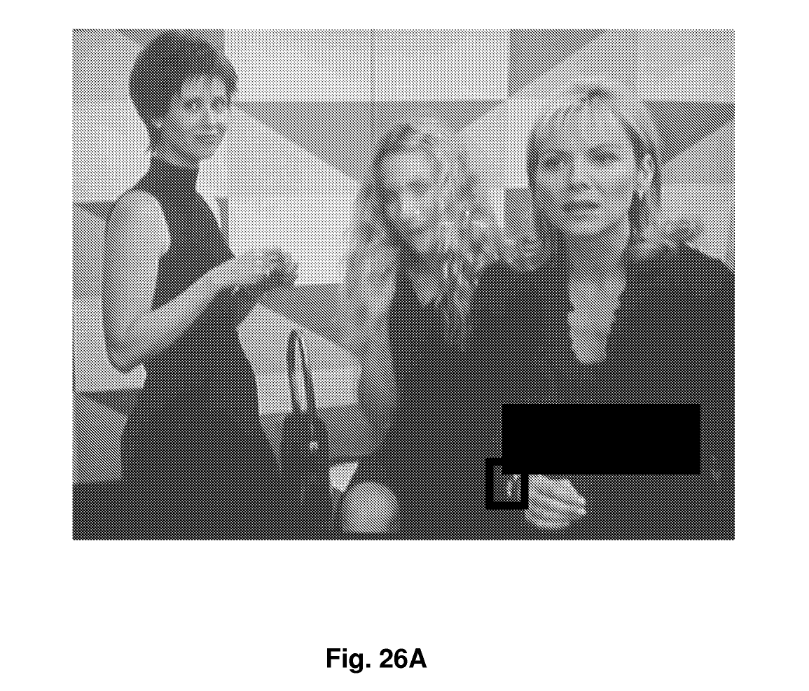

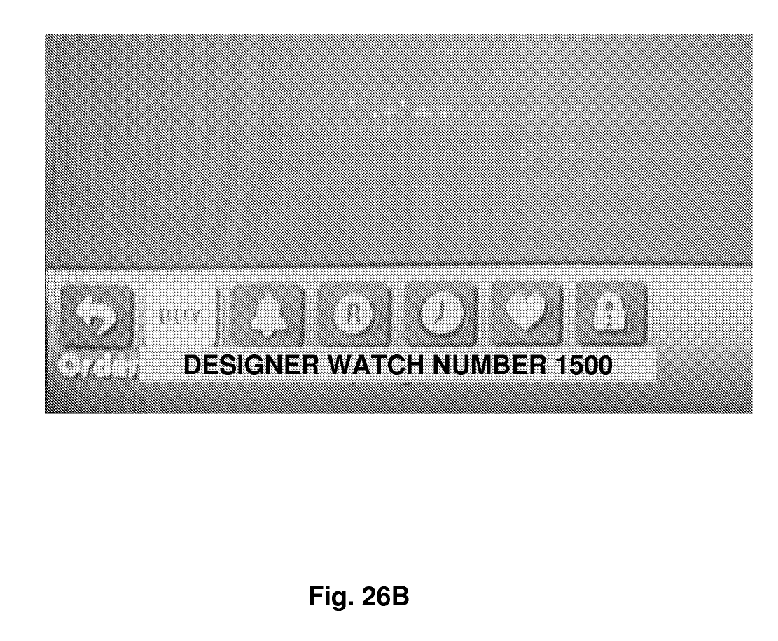

FIG. 25A is a screen shot of a cable television on-demand show viewable on the audiovisual system 50 of FIG. 1 showing an onscreen item selector in accordance with preferred embodiments of the present invention. FIG. 25B is a screen shot of an information detail and purchasing selection menu bar displayed in accordance with selection of an item in FIG. 25A. FIG. 25B shows that the selected item is a “Designer Jewelry Number 1400.” Of course, other more detailed information can also be displayed such as sizes, materials, accessories and the like. If the user actually wants another item 1000, 1100, 1200, 1300, 1500 shown on the screen, the user uses the navigation keys on the remote control 102 to tab to the next or previous item, such as FIG. 26A.

FIG. 26A is a screen shot of a cable television on-demand show viewable on the audiovisual system 50 of FIG. 1 showing an onscreen item selector in accordance with preferred embodiments of the present invention. FIG. 26B is a screen shot of an information detail and purchasing selection menu bar displayed in accordance with selection of an item in FIG. 26A. FIG. 26B shows that the selected item is a “Designer Watch Number 1500.” Of course, other more detailed information can also be displayed such as sizes, materials, accessories and the like. If the user actually wants another item 1000, 1100, 1200, 1300, 1400 shown on the screen, the user uses the navigation keys on the remote control 102 to tab to the next or previous item, such as FIG. 25A of FIG. 23A.

Of course, any number of items 1000, 1100, 1200, 1300, 1400, 1500 may be selectable within a scene and/or within an AV program. Other items 1000, 1100, 1200, 1300, 1400, 1500 may include big ticket items like computer systems, motor vehicles, appliances and the like. Instead of directly purchasing the items, the query may provide the user with information about a nearby store or dealership based upon their location data in their user profile. Alternatively, the user can comparison shop for the selected item at a plurality of stores or Internet web-sites after the item is selected using the online shopping and item selection system 90.

In some embodiments, the online shopping and item selection system 90 allows the user to pause or interrupt the program similar to a digital video disc/digital versatile disc (DVD) or a video cassette player/recorder (VCP/VCR). The user can than select items 1000, 1100, 1200, 1300, 1400, 1500 on the screen using a menu selection button on a remote control 102. The menu button may be a multipurpose soft-button or may be a dedicated button like “Next Item” or “Previous Item” and the like. To select items such as clothing that actors are wearing or other objects within the picture such as accessories or furniture, the user uses the menu selection button to “tab” to the next item. Alternatively, the remote control 102 can include a joystick, trackball, touchpad, mouse, tablet or other multipositional input device to select a precise location of an item on the screen. Optionally, the remote control 102 can include voice recognition controls responsive to spoken words like “shop mode,” “next,” “last,” “buy now,” and the like. Optionally, when available, the user can use a touchscreen interface to select items on the screen 52.

Once the user has selected an item, the user selects an “information” or “selection” button to get more information on the selected item. The system 90 can permit the user to enlarge the item for a better view or can show the user an array of detailed images with different views of the item (e.g., perspective, top, bottom, side, front, interior, exploded, etc.). Further, the system 90 can show the sizes, colors and optional features available for a particular item.

For example, a name brand dress 1000, 1100, 1200 may be available in petit, small, medium and large or may be available in numbered dress sizes like 2, 4, 6, 8 and 10. Additionally the name brand dress 1000, 1100, 1200 may come in various colors like black, red, chartreuse, pomegranate and ebony. The name brand dress 1000, 1100, 1200 may also come with optional accessories like a belt, a support halter-top, integral brazier, shoulder pads, jewelry and the like.

The user can then obtain more detail information about the purchasing of the item such as price, shipping costs, tax, availability, name-brand, source of origin, and the like. If the user wishes to purchase the item, the user can choose the size, quantity, color, accessories, shipping method using the remote control or other input device 102. The item can be added to a shopping cart similar to U.S. Pat. No. 5,960,411 (“Hartman, et al.,” hereinafter, “Hartman”), the contents of which is incorporated by reference herein. Additionally, the item can be purchased immediately using a “one-click shopping” feature similar to Hartman. Alternatively, the user may have an account set-up with their service provider such that any purchases will be invoiced to them in their monthly bill or charged to a credit card or bank account. The user may optionally shop using other electronic accounts like Microsoft Wallet, Pay-Pal, credit card accounts, and the like.

Other combinations of screens, menus, menu choices and selection fields may be used without departing from the present invention.

The present invention may be implemented with any combination of hardware and software. For example, the online shopping control software may be run locally on a personal computer from a hard disk or CDROM or over a network connection such as by way of a web page accessible over an Intranet or the Internet or through bidirectional cable television or bidirectional satellite.

The software may also be run on a set-top terminal 54 such as a cable television or satellite television control box or other dedicated computational device. The software may be run through a device such as a DVD player, a Tivo control box, a Replay control box or the like.

Other hardware, operating systems, software packages and user interfaces may be utilized without departing from the present invention. If implemented as a computer-implemented apparatus, the present invention is implemented using means for performing all of the steps and functions described above.

Embodiments of the present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

The personal computer system 60 in which at least a portion of the system of the present invention can be embodied can be any type of general purpose computer system, such as a personal computer (PC), server, workstation, personal digital assistant (PDA), and the like, running any one of a variety of operating systems. In addition, software embodying the present invention may, in one embodiment, reside in an application running on the personal computer system 60.

Embodiments of the present invention can also be embodied in a computer-readable program medium usable with a computer system such as the personal computer system 60. The personal computer system 60 typically includes a central processor unit, a main memory unit for storing programs and/or data, an input/output controller, a network interface, a display device such as a monitor, one or more input devices, a fixed or hard disk drive unit, a floppy disk drive unit and a data bus 30 coupling these components to allow communication therebetween. The central processor can be any type of microprocessor, such as a PENTIUM processor made by Intel of Santa Clara, Calif. The display device can be any type of display, such as a liquid crystal display (LCD), cathode ray tube display (CRT), light emitting diode (LED), and the like, capable of displaying, in whole or in part, the outputs generated in accordance with the systems and methods of the invention.

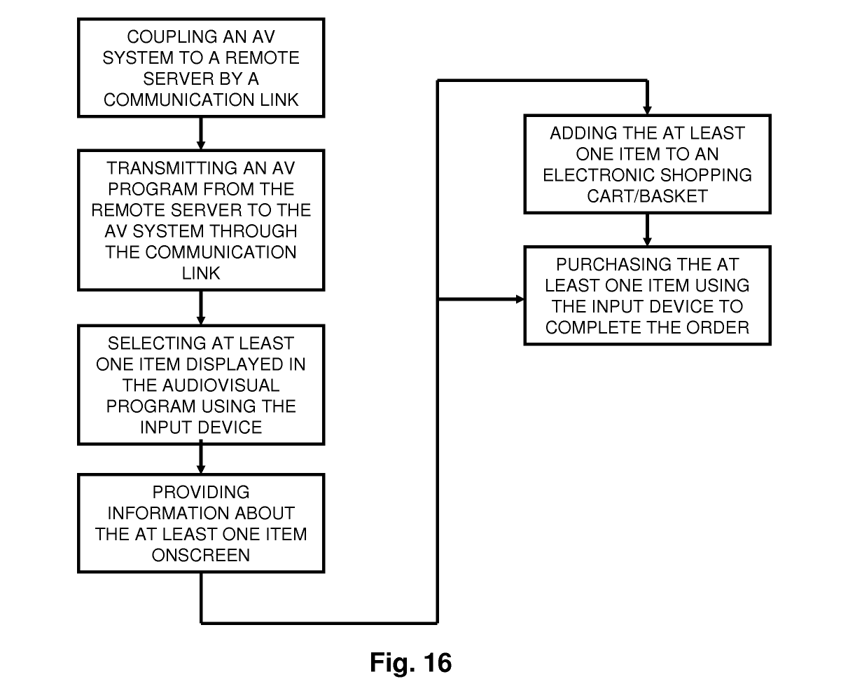

FIG. 16 is a flowchart of a method of purchasing at least one item 1000, 1100, 1200, 1300, 1400, 1500 through an audiovisual system 50 in accordance with preferred embodiments of the present invention. The method includes coupling the audiovisual system 50 to the central server 85 by a communication link 99. An AV program, such as a pre-recorded movie or live television program, is transmitted from the remote server 85 to the AV system 50 through the communication link 99. The user selects at least one item 1000, 1100, 1200, 1300, 1400, 1500 displayed in the AV program using the input device or remote control 120. Information about the at least one item 1000, 1100, 1200, 1300, 1400, 1500 is displayed on the display 52. The user can use the remote control 120 to select one or more of the items 1000, 1100, 1200, 1300, 1400, 1500 on the display 50. The user can immediately purchase using a “buy now” or “buy” button, like one-click shopping, or the user can add the selected items 1000, 1100, 1200, 1300, 1400, 1500 to a virtual or electronic shopping cart/basket. The electronic shopping cart/basket may reside in local memory at the audiovisual system 50 and/or at the remote server 85 or an intermediate server 85. The user can then use the remote control 120 to check-out their final order providing additional billing information such as ship-to address, sales tax, payment method and the like.

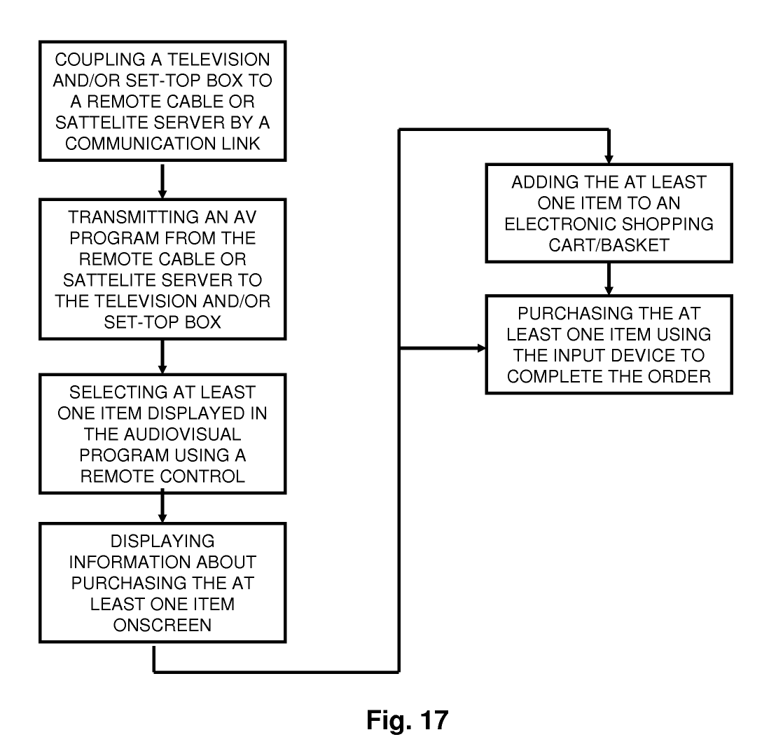

FIG. 17 is a flowchart of a method of purchasing at least one item 1000, 1100, 1200, 1300, 1400, 1500 through a cable or satellite server 85 using a television 51 and/or set-top box 54 in accordance with preferred embodiments of the present invention. The method includes coupling television 51 and/or set-top box 54 to the central server 85 by a communication link 99. An AV program, such as a pre-recorded movie or live television program, is transmitted from the remote server 85 to the television 51 and/or set-top box 54 through the communication link 99. The user selects at least one item 1000, 1100, 1200, 1300, 1400, 1500 displayed in the AV program using the input device or remote control 120. Information about the at least one item 1000, 1100, 1200, 1300, 1400, 1500 is displayed on the display 52. The user can use the remote control 120 to select one or more of the items 1000, 1100, 1200, 1300, 1400, 1500 on the display 50. The user can immediately purchase using a “buy now” or “buy” button, like one-click shopping, or the user can add the selected items 1000, 1100, 1200, 1300, 1400, 1500 to a virtual or electronic shopping cart/basket. The electronic shopping cart/basket may reside in local memory at the television 51 and/or set-top box 54 and/or at the remote server 85 or an intermediate server 85. The user can then use the remote control 120 to check-out their final order providing additional billing information such as ship-to address, sales tax, payment method and the like.

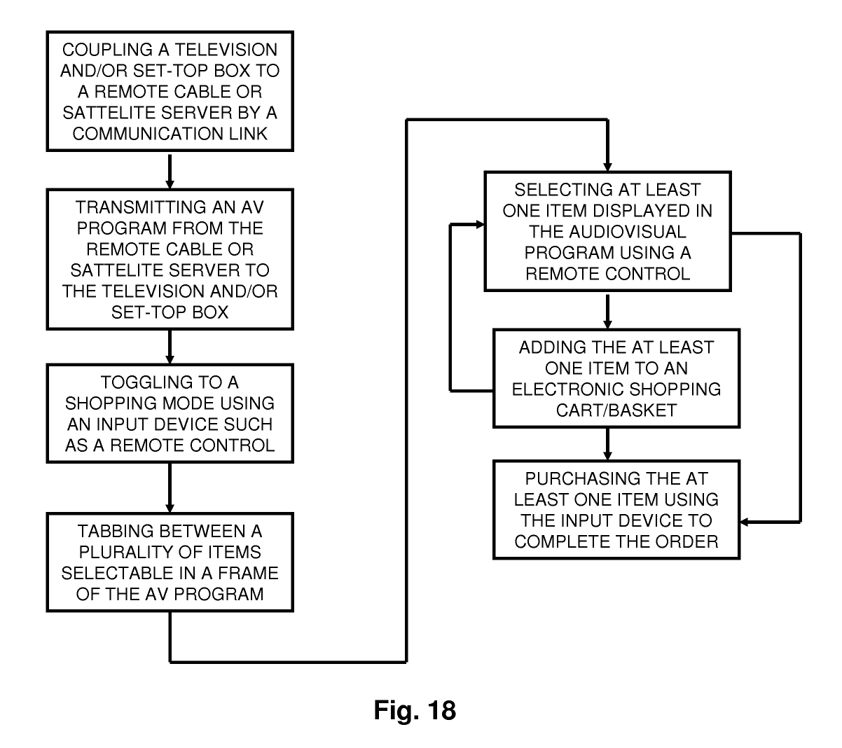

FIG. 18 is a flowchart of another method of purchasing at least one item 1000, 1100, 1200, 1300, 1400, 1500 through a cable or satellite server using a television 51 and/or set-top box 54 in accordance with preferred embodiments of the present invention. The method is similar to that described in FIG. 17, but further includes the user toggling to a shopping mode using the remote control 120. The user can then tab through a plurality of items 1000, 1100, 1200, 1300, 1400, 1500 selectable in a frame or frames of the AV program. The user can immediately purchase using a “buy now” or “buy” button, like one-click shopping, or the user can add the selected items 1000, 1100, 1200, 1300, 1400, 1500 to a virtual or electronic shopping cart/basket. The electronic shopping cart/basket may reside in local memory at the television 51 and/or set-top box 54 and/or at the remote server 85 or an intermediate server 85. The user can repeatedly add more items to the electronic shopping cart/basket from other frames within the AV program. The user may be able to skip to the next or the last frame that includes items 1000, 1100, 1200, 1300, 1400, 1500 that are selectable within the AV program over and over. The user can also delete items 1000, 1100, 1200, 1300, 1400, 1500 from the electronic shopping cart/basket. The user can then use the remote control 120 to check-out their final order providing additional billing information such as ship-to address, sales tax, payment method and the like. Alternately, the user can save items 1000, 1100, 1200, 1300, 1400, 1500 in the electronic shopping cart/basket for later purchase and/or update.

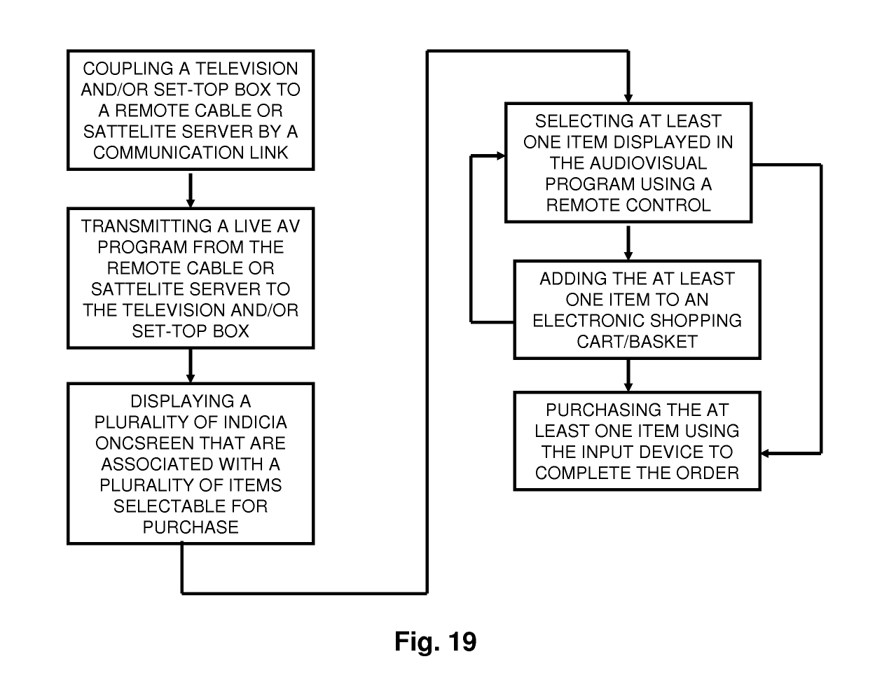

FIG. 19 is a flowchart of another method of purchasing at least one item 1000, 1100, 1200, 1300, 1400, 1500 through a cable or satellite server 85 using a television 51 and/or set-top box 54 in accordance with preferred embodiments of the present invention. The method is similar to that described in FIG. 17, but further includes displaying a plurality of indicia (see FIG. 15) on the display 52 associated with a plurality of items 1000, 1100, 1200, 1300, 1400, 1500 selectable for purchase. The user can then tab through a plurality of items 1000, 1100, 1200, 1300, 1400, 1500 selectable in a frame or frames of the AV program. Alternately, the user can type in a number or code associated with a desired item like the designator in the indicia. For example, if the user wishes to purchase item 1500, the user could type in “1500” using the remote control 120. The user can immediately purchase using a “buy now” or “buy” button, like one-click shopping, or the user can add the selected items 1000, 1100, 1200, 1300, 1400, 1500 to a virtual or electronic shopping cart/basket. The electronic shopping cart/basket may reside in local memory at the television 51 and/or set-top box 54 and/or at the remote server 85 or an intermediate server 85. The user can repeatedly add more items to the electronic shopping cart/basket from other frames within the AV program. The user may be able to skip to the next or the last frame that includes items 1000, 1100, 1200, 1300, 1400, 1500 that are selectable within the AV program over and over. The user can also delete items 1000, 1100, 1200, 1300, 1400, 1500 from the electronic shopping cart/basket. The user can then use the remote control 120 to check-out their final order providing additional billing information such as ship-to address, sales tax, payment method and the like. Alternately, the user can save items 1000, 1100, 1200, 1300, 1400, 1500 in the electronic shopping cart/basket for later purchase and/or update.

In one embodiment of the present invention, one or more computer programs define the operational capabilities of the personal computer system 60. These programs can be loaded into the personal computer system 60 in many ways, such as via the hard disk drive, the floppy disk drive, the tape drive, or the network interface. Alternatively, the programs can reside in a permanent memory portion (e.g., a read-only-memory (ROM)) chip) of the main memory. In another embodiment, the personal computer system 60 can include specially designed, dedicated, hard-wired electronic circuits that perform all functions described herein without the need for instructions from computer programs.

The network interface can be any type of a device, card, adapter, or connector that provides each audiovisual system 50 and/or personal computer system 60 with network access to a remote server computer 85 or other remote storage device. In one embodiment of the present invention, the network interface enables the audiovisual system 50 and/or personal computer system 60 to connect to a computer network such as the Internet.

The personal computer system 60 can be part of a client-server system, in which a client sends requests to a server 85 and a server 85 responds to requests from a client 60. That is, the personal computer system 60 can be either a client system or a server system or both.

Of course, embodiments of the present invention are typically implemented at the server side such as a cable provider head-end or central server 85 which responds to requests made from a client.

From the foregoing, it can been seen that the present inventions comprises an online shopping and item selection system and method, and more particularly, to an online shopping and item selection system and method implemented with cable television, satellite television and Internet broadcasting. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An online shopping and item selection system comprising:
an audiovisual system including a video display;
a communication link coupled to the audiovisual system;
a remote cable\satellite server coupled to the audiovisual system through the communication link;
an input device selectively coupled to the audiovisual system;
an audiovisual program transmitted from the remote cable\satellite server by a cable\satellite service provider to the audiovisual system, the video display displaying the audiovisual program; and
at least one item displayed within the audiovisual program that is selectable using the input device,
one of the audiovisual system and the audiovisual program being configured to be selectively switchable to a shopping mode that permits a user to select among a plurality of items within the audiovisual program to purchase a selected item using a previously set-up user payment account with the cable\satellite service provider so that any purchases are invoiced to the user in a user's monthly bill from the cable\satellite service provider.

2. The online shopping and item selection system according to claim 1, wherein one of the audiovisual system and the audiovisual program is switched to an information mode that permits the user to select among a plurality of items within the audiovisual program to obtain information about the selected item.

3. The online shopping and item selection system according to claim 2, wherein the input device is a remote control having a plurality of buttons including up select, down select, right select, left select and OK/select keys,

4. The online shopping and item selection system according to claim 3, wherein the user uses one of the plurality of buttons of the input device to switch to the shopping/information mode and uses one or more of the plurality of buttons of the input device to select among the plurality of items.

5. The online shopping and item selection system according to claim 1, wherein the audiovisual system includes at least one of a television, a personal computer, a set-top terminal, a personal digital assistant (PDA), a cellular telephone and a digital playback device.

6. The online shopping and item selection system according to claim 1, wherein the audiovisual program is transmitted with data compression encoding/decoding data.

7. The online shopping and item selection system according to claim 1, wherein one of the audiovisual system and the audiovisual program is selectively switchable to an information mode that permits the user to select among a plurality of items within the audiovisual program to get information or purchase a selected item.

8. The online shopping and item selection system according to claim 1, wherein the audiovisual program is one of a live broadcast, an on-demand movie, an on-demand show, a shopping show, a television show, a mini-series, a pre-recorded movie and a pre-recorded show.

9. The online shopping and item selection system according to claim 1, wherein the input device is one of a remote control, a personal digital assistant (PDA), a mouse, a trackball, a keyboard, a touchscreen, a touchpad and a pointing device.

10. The online shopping and item selection system according to claim 1, wherein the communication link comprises one or more of a cable television system, a satellite television system, a wireless local area network, a wireless wide area network, a telephone system, the Internet and a dedicated network.

11. The online shopping and item selection system according to claim 1, further comprising:
a menu that is selectively displayable on the video display, the menu including information about purchasing the at least one item onscreen.

12. A method of online shopping and item selection comprising:
coupling an audiovisual system to a remote cable\satellite server by a communication link;
transmitting an audiovisual program from the remote cable\satellite server by a cable\satellite service provider to the audiovisual system through the communication link, one of the audiovisual system and the audiovisual program being configured to be selectively switchable to a shopping mode that permits a user to select among a plurality of items within the audiovisual program to purchase a selected item using a previously set-up user payment account with the cable\satellite service provider so that any purchases are invoiced to the user in a user's monthly bill from the cable\satellite service provider;
selecting at least one item displayed in the audiovisual program using an input device;
providing information about the at least one item onscreen; and
purchasing the at least one item using the input device to complete the transaction.

13. The method according to claim 12, further comprising:
immediately purchasing the at least one item using a one-click purchasing selection.

14. The method according to claim 12, further comprising:
adding the at least one item to an electronic shopping cart/basket.

15. The method according to claim 12, wherein the information about the at least one item includes one of price, available sizes, available colors, technical specifications, availability for shipment, shipping options, shipping costs and purchasing terms.

16. The method according to claim 12, wherein the audiovisual program is one of a live broadcast, an on-demand movie, an on-demand show, a shopping show, a television show, a mini-series, a pre-recorded movie and a pre-recorded show.

17. A method of online shopping comprising:
coupling one of a television and a set-top box to a remote cable\satellite server by a communication link;
transmitting an audiovisual program from the remote cable\satellite server by a cable\satellite provider to the respective one of the television and the set-top box through the communication link, one of television, the set-top box and the audiovisual program being configured to be selectively switchable to a shopping mode that permits a user to select among a plurality of items within the audiovisual program to purchase a selected item using a previously set-up user payment account with the cable\satellite service provider so that any purchases are invoiced to the user in a user's monthly bill from the cable\satellite service provider;
selecting at least one item displayed in the audiovisual program using an input device;
displaying information about purchasing the at least one item onscreen; and
purchasing the at least one item using the input device to complete the transaction.

18. The method according to claim 17, further comprising:
immediately purchasing the at least one item using a one-click purchasing selection.

19. The method according to claim 17, further comprising:
adding the at least one item to an electronic shopping cart/basket.

20. The method according to claim 17, wherein the communication link comprises one or more of a cable television system, a satellite television system, a wireless local area network, a wireless wide area network, a telephone system, the Internet and a dedicated network.
